(19) United States
(12) Patent Application Publication
(10) Pub. No.: US 2013/0275296 A1
(43) Pub. Date: Oct. 17, 2013

(54) Proximal Customer Transaction Incented By Donation of Auto-Boarded Merchant

(71) Applicants: Terrance Patrick Tietzen, Edmonton (CA); Matthew Arnold Macpherson Bates, Edmonton (CA); William Gordon Robertson, Edmonton (CA)

(72) Inventors: Terrance Patrick Tietzen, Edmonton (CA); Matthew Arnold Macpherson Bates, Edmonton (CA); William Gordon Robertson, Edmonton (CA)

(73) Assignee: esdatanetworks INC, Edmonton (CA)

(21) Appl. No.: 13/834,984

(22) Filed: Mar. 15, 2013

Related U.S. Application Data
(63) Continuation-in-part of application No. 13/748,459, filed on Jan. 23, 2013.
(60) Provisional application No. 61/611,876, filed on Mar. 16, 2012.
(60) Provisional application No. 61/732,152, filed on Nov. 30, 2012.

(51) Int. Cl. G06Q 30/02

(52) U.S. Cl. CPC G06Q 30/0279; G06Q 30/0207
USPC 705/39

(57) ABSTRACT

Address, time, and rules obligating donee donations are auto-populated for merchants whose authorization responses for transactions conducted on accounts are used to obtain account holders' travel time to the merchants'. When travel time is proximal to the auto-populated time, the rule and the transaction currency amount are used to calculate the merchant's donee donation, which donation can be messaged for auditing of donations paid and payable. A predetermined time after each such transaction, the merchant is sent a notice as to the difference between obligatory donee donations and the donee donations received. Auto-populated addresses, times, and rules are amendable by the merchant, and the donee amendable by the account holder, whereby the merchant selects the donation, and the account holder selects the donee. Answers to account holder surveys, upon receipt, increments currencies for account holder or donee with greater increment for fast answers.

### CROSS REFERENCE TO RELATED APPLICATIONS

This utility patent application claims priority to U.S. Provisional Application Ser. No. 61/611,786, titled “Cashless Payment System Affinity Donations,” filed on Mar. 16, 2012, and to U.S. Provisional Application Ser. No. 61/732,152, titled “Customer Voice Order Triggered Mutual Affinity Merchant Donation,” filed on Nov. 30, 2012, and to U.S. Utility patent application Ser. No. 13/748,459, titled “Authorized Transaction Incented By Merchant Donation,” filed on Jan. 23, 2013, each of which is incorporated herein by reference.

### FIELD

Implementations generally relate to incentives by merchants to encourage purchases by consumers who are most likely to make purchases, more particularly to relate to merchants sending messages to consumers who are most likely to make purchases that encouraging transactions for which the merchants will make donations, and most particularly relate to automatically populating systems with data sufficient to allow merchants to encourage consumers that are most likely to make purchases to conduct transactions on accounts issued to them by issuers in exchange for the merchants making donations to entities with whom the merchants and/or the consumers have an affinity.

### BACKGROUND

Merchants often use techniques to prompt consumers into making a particular purchase. These techniques are commonly in the form of monetary incentives, relying on the principle that a lower price will result in increased sales. Merchants may employ these techniques, for example, to help clear inventory before a new season's merchandise is released, to ease the release of a new product, to increase sales near the end of the fiscal year, to compete with a competitor over particular products, or to generally spur sales. Monetary incentives may come in the form of a “sale” (i.e., temporary reduction in price at the register), a discount coupon, a mail-in rebate (i.e., a refund of part or the entire purchase price by mail), or a store credit (i.e., credit that can be applied to another store purchase). These incentives usually only apply to a particular product and have a time component. For example, a sale may only apply to a particular brand of dishwasher purchased on a particular holiday weekend and a rebate may only be valid for computers purchased within two weeks before the start of classes at a university.

For some credit transactions, a merchant may also use a statement credit as a monetary incentive. A statement credit is an amount refunded back to a credit account and appears on the account holder's account statement. Using a statement credit as a monetary incentive involves two distinct transactions. In the first transaction, the merchant charges the full amount to a customer's credit account. In the second transaction, the amount of the monetary incentive is then refunded back to the customer's credit account as a statement credit.

Statement credit campaigns offer an advantage for merchants over other types of monetary incentive programs because a transaction handler, such as Visa Inc. or MasterCard Inc., largely handles the administration of the campaign. Once a statement credit campaign is arranged and initiated between a merchant and a transaction handler, the transaction handler tracks the statement credit, matches the statement credit to qualifying purchases, and credits the amount of the statement credit to the purchaser's account. The transaction handler then collects the aggregate amount of the statement credits made to multiple purchasers from the merchant.

Although consumers are typically incented to make purchases by a form of price reduction, non-monetary reasons also motivate consumers to make purchases with a merchant, for instance where the consumers believes that the merchant is a force for good and thus the consumers are non-monetarily incented to do business with the merchant who they deem worthy of such support. As such, it would be an advance in the art to provide a non-monetary incentive motivate a consumer to conduct a transaction with a merchant.

Another problem for merchants, especially small to mid-sized merchants, is that an increasing number of transactions are conducted online instead of inside brick and mortar stores. Online transactions conducted with larger merchants can represent a loss in sales to traditional small and medium size merchants whose main business method to attractive sales is a traditional retail, brick and mortar store environment, instead of mail orders, telephone orders, and/or electronic commerce (e-commerce) transactions. The loss of the in-store purchase is a lost opportunity for the local merchant and local customer to get to know each other, personally, and a lost opportunity for the local customer to become a live advertisement for the merchant's retail store and its wares. Online sales also prohibit the traditional brick and mortar merchant from an opportunity to sell customers in a retail environment best understood by the merchant. The loss of in-store purchases to online sales causes economic problem for traditional small and medium size merchants and the communities they serve. In some neighborhoods, the number of small retail shops has dramatically declined, leaving community commercial areas in a state of blight and disuse. In addition to economic downturn sensitivities, small, family-owned stores also face extinction threats from sophisticated online retailers, with resultant losses to local community retail diversity and neighborhood health with the death of the neighborhood ‘mom-and-pop’ store. Neighborhood streets can seem vacant during the day and open only after 5 p.m. to serve the interests of only one demographic, namely young urban professionals with disposable income. Previously successful businesses have been closing when e-commerce competition from online auctions and retailers attract previously loyal neighbors. Accordingly, it would be an advance in the art of commerce to provide a system of incentives to neighborhood customers to engage in neighborhood brick and mortar, in-person transactions. It would be a further advance in the art of commerce to provide a system that shifts sales revenue towards neighborhood merchants away from electronically competing merchants. It would be a still further advance in the art of commerce to provide a system that shifts sales tax revenue towards neighborhood authorities that would otherwise be lost to e-commerce transactions. It would also be an advance in the art of commerce to provide a system that incents local merchants in the community to receive foot traffic from customers that are incidentally doing in-person shopping with other brick and mortar merchants. A yet further advance in the art of commerce would be to provide a system that provides an incentive to a customer, who would have otherwise only window-shopped a product at the brick and mortar store of a local merchant but then buy that product on-line from an electronic competitor merchant, to buy that product at the brick and mortar store of the local merchant.

Studies show that a significant portion of spending by a consumer is geographically restricted to a region that is proximal to where a consumer resides. Yet another problem for merchants, especially small to mid-sized merchants, are inefficiencies in attracting consumers to their brick and mortar stores which are within the geographically close region to where those consumers reside. A still further advance in the art of commerce would be to provide a system that provides incentives to consumers who are likely to shop at brick and mortar stores within a geographically region that is close to where those consumers reside.

Given the above and other numerous problems imposed upon available sales and marketing resources available to small and medium sized business merchants in designing, implementing, and maintaining consumer incentive programs, it would be an advance in the relevant arts to provide systems that are automatically populated with information sufficient to enable merchants to give non-monetary incentives to their customers who will conduct transactions with them, where these systems allow the merchant to offload the processing burden of managing the non-monetary consumer incentives.

### SUMMARY

In a computerized implementation, merchant data is auto-populated to include an address, duration, and a rule obligating the merchant to donate to a donee. Information from an authorization response for a transaction conducted by the merchant on an account of an account holder is used to obtain a travel time of the account holder from its address to the auto-populated address. When the obtained travel time is within a predetermined threshold of the auto-populated duration, a donation that the merchant is obligated to make to the auto-populated donee is derived by using the auto-populated rule and a currency amount of the trans action.

In another computerized implementation, there is obtained, from one or more databases, using information derived from a Globally Unique Identifier (GUID) for a merchant, merchant data for the merchant. The merchant data for the merchant includes: (i) a geographic address for the merchant; (ii) a default affinity entity or donee; (iii) a default maximum travel time to the geographic address for the merchant; and; (iv) a default business rule obligating the merchant to make a donation to the affinity entity. The merchant data for the merchant, now auto-populated, is stored in one or more databases. Information derived from an authorization response for a transaction conducted by the merchant on an account issued to an account holder is processed. This processing of the information includes (i): retrieving, using the identifier for the merchant, at least a portion of the stored merchant data for the merchant; (ii) accessing from one or more databases, using information derived from the identifier for the account holder, account holder data for the account holder that includes a geographic address for the account holder; (iii) inquiring, using the geographic addresses for the account holder and the merchant, the travel time from the geographic address of the account holder to the geographic address of the merchant; and (iv) if the retrieved travel time is within a predetermined tolerance of the default maximum travel time, deriving, using the default business rule and the currency amount of the transaction, the donation to be made by the merchant to the default affinity entity. Optionally, a message can be transmitted to a logical address of the merchant containing the donation to be made by the merchant to the default affinity entity.

In an alternative implementation of the foregoing implementation, the obtaining and storing are repeated for a plurality of the merchants and the processing for each of a plurality of the transactions is also repeated. Optionally, the processing can include transmitting a message to a logical address of the merchant containing the donation to be made by the merchant to the default affinity entity. As a further option, the logical address to which the message and the determined difference are transmitted can be any or all or a logical address for the merchant, the account holder, the affinity entity, an agent for at least one of the merchant, the account holder and the affinity entity, and combination of these.

In a further implementation, a predetermined time after the plurality of the transactions, a plurality of donation receipts can be received, each of which includes identifiers for the merchant and the default affinity entity, and a currency amount donated by the merchant to the default affinity entity. For each of the default affinity entities and for each of the merchants, a determination is made of the difference between the sum of the donations to be made by the merchant to the default affinity entity in the messages to the logical address of the merchant and the currency amount donated by the merchant to the default affinity entity in the donation receipts. The determined difference can then be transmitted to a logical address, for instance, which can be that of the logical address of the merchant, the account holder, the affinity entity, an agent for at least one of the merchant, the account holder and the affinity entity, and combination of these.

In a yet further implementation, each of the transactions occurs in a payment processing system that includes a plurality of the merchants each conducting each of the transactions on a respective account issued to a respective account holder by a respective issuer. Each transaction on each said account is acquired for clearing and settlement by an acquirer for each said merchant through a transaction handler in communication with both the issuer of the account and the acquirer for the merchant. The issuer sends a corresponding authorization response for the transaction to the merchant through the transaction handler and the acquirer in response to an authorization request sent to the issuer from the merchant through the transaction handler and the acquirer.

Prior to repeating the processing step for each of a plurality of the transactions, replacement changes to be default terms, conditions, and values can be received, on behalf of one or more of the merchants. By way of examples, there can be received changes for a merchant that can replace at least one these: (i) the default affinity entity corresponding to the geographic address for the merchant; (ii) the default maximum travel time to the geographic address for the merchant; (iii) and/or the default business rule obligating the merchant to make a donation to the affinity entity. Also, there can be received for one or more account holders changes to the default affinity entity for the donation that is to be made by the merchant for each said transaction with said account holder, which default affinity entity that is replaced may have originally corresponded to, or be proximal of, the geographic address for the merchant.

After each transaction, in various alternative implementations, a message containing a question can be transmitted to a logical address of the account holder for the transaction. The message will contain one or more survey questions posed to the account holder or its agent. After receiving, in response to the survey, an answer, and as an incentive to the account holder to answer the survey, an increment is made in one or more databases to a loyalty currency attributed to the account holder. As acknowledgement that the incentive was accorded, a message can be transmitted to the logical address of the account holder containing acknowledgement of the increment to the loyalty currency. If the answer is received within a predetermined tolerance (e.g., quickly), the increment to the loyalty currency attributed to the account holder will be greater than the increment if the time lapse is not within the predetermined tolerance, which greater increment can be in the message that is transmitted to the logical address of the account holder.

Optionally, the survey answers by an account holder or its agent who transacted with a merchant can be sent, by batch or in real time, to a logical address of the merchant or its agent. As a still further option, a publication of a hyperlink can be made, or a facilitation of the network access can be made, to survey answers for the merchants and their account holders of all of a subset of the transactions. Third party requests can be received and responses thereto sent, by way of a user interface that provided third parties with a search engine to query and review survey answers for a particular merchant.

### BRIEF DESCRIPTION OF THE DRAWINGS

FIGS. 1-2 are flowcharts illustrating respective exemplary processes that allow an account holder to make a purchase of goods and/or services from a merchant, where the account holder's transaction obligates the merchant to make a donation to an affinity entity that make also be a charitable organization (e.g., a charity);

FIG. 3 illustrates an exemplary payment processing system in which the processes of FIGS. 1-2 can be performed, where the system processes transactions conducted by merchants with account holders, wherein, for each transaction, there is a provision of a service and/or good by the merchant to the account holder for the transaction which is conducted on an account issued to the account holder by an issuer, there is an authorizing and remunerating of an electronic payment by the account holder in conducting the transaction on the account with the merchant, and there are one or more donations by the merchant that are made to respective affinity entities or charities incident to the transaction;

FIG. 4 illustrates an exemplary open loop payment processing system for transactions conducted by merchants with account holders, wherein, for each transaction, there is a provision of a service or good by the merchant to the account holder for the transaction on an account issued to the account holder by an issuer, there is an authorizing and remunerating of an electronic payment by the account holder in conducting the transaction on the account with the merchant, and wherein the exemplary process illustrated in FIG. 5 can be performed in an environment consistent with the system depicted in FIG. 4 for automatically populating databases to process and account for contributions incident to transactions in the open loop cashless payment processing system;

FIG. 5 is a flowchart illustrating an exemplary process for automatically populating databases to allow information to be sent to account holders conveying that merchants will contribute to entities with which the account holders and/or the merchants have affinities, where each contribution is made following a transaction between a merchant and an account holder on an account issued to the account holder by an issuer;

FIG. 6 is a flowchart illustrating an exemplary process, extending those processes illustrated in FIGS. 1 and 5, to send an incentive-bearing survey to each account holder transacting with each merchant who will make a contribution to an affinity entity, receiving survey results back from each account holder, and publishing searchable survey results;

FIG. 7 illustrates, for a Merchant having a geographic address within one type of a low population density Merchant-Community, navigation algorithm time results for each of a plurality of transportation modes that might be used by an Account Holder to travel from a geographic address associated with the Account Holder to the geographic address of the Merchant;

FIG. 8 illustrates, for a Merchant having a geographic address within one type of a high population density Merchant-Community, navigation algorithm time results for each of a plurality of transportation modes that might be used by an Account Holder to travel from a geographic address associated with the Account Holder to the geographic address of the Merchant;

FIGS. 9a and 9b illustrate screen shots characterizing exemplary user interfaces for use by a merchant and for an account holder, respectively, to designate contributions to be made to respective entities incident to a transaction there between, where each such entity corresponds to an affinity of the Merchant, the Account Holder and/or both;

FIG. 10a illustrates a screen shot characterizing an exemplary user interfaces for use by a merchant to show, inter alia, donations paid and payable to respective affinity entities for respective transactions with respective Account Holders;

FIG. 10b illustrates a screen shot characterizing an exemplary user interfaces for use by an Affinity Entity showing, inter alia, donations paid and payable by respective Merchants as derived from their respective transactions with respective Account Holders;

FIG. 11a illustrates a screen shot characterizing an exemplary user interface for the display and updating of information pertaining to transactions conducted by Account Holders and their respective logical and geographic addresses and Account Affinity Donation Rules;

FIG. 11b illustrates a screen shot characterizing an exemplary user interface to display and updating of information pertaining to transactions conducted between Account Holders at respective Merchant geographic addresses resulting in respective donations paid and payable by the Merchants to respective Affinity Entities;

FIG. 12a illustrates a screen shot characterizing, inter alia, an exemplary user interface for a merchant to designate terms and conditions, as conditioned by navigation times for respective modes of transportation or travel from a geographic address attributed to an Account Holder to a geographic address attributed to the Merchant, under which the Merchant will make a donation incident to each transaction with each Account Holder;

FIG. 12b illustrates a screen shot characterizing an exemplary user interface for an Account Holder to specify one or more affinity entities to whom a donation will be made by a Merchant with whom the Account Holder conducts a transaction on an account issued to the Account Holder;

FIG. 13 illustrates a display screen for displaying a user interface on which is displayed a received and rendered survey corresponding to a transaction conducted by an Account Holder with a Merchant, to which the Account Holder can submit one or more survey responses as shown by progressive screen shots as illustrated in FIG. 13,

FIG. 14 illustrates exemplary systems housed within an interchange center to provide online and offline transaction processing for transactions conducted using the payment processing system illustrated in FIGS. 1 and 3-4; and

FIG. 15 illustrates further exemplary details of the systems illustrated in FIG. 14.

Implementations will become more apparent from the detailed description set forth below when taken in conjunction with the drawings, in which like elements bear like reference numerals.

### DETAILED DESCRIPTION

In one computerized implementation, a process automatically populates one or more databases to allow information to be sent to account holders conveying that merchants will make contributions to an entity to which the account holders and/or the merchants have an affinity, where each contribution is a function of a currency amount of each transaction conducted between each merchant and each account holder on an account issued to the account holder by an issuer. The affinity, by way of example, can be based on an entity that is designated by the merchant, designated by the account holder, and/or designated by a third party. Alternatively, the affinity can be based upon a community to which the account holders and/or the merchants belong, such as being based upon a geographic area where the transaction takes place, where the merchant is located, and/or where the account has an account billing address. After each account holder receives notice of each merchant's intent to give to the community, those account holders respond by transacting with the merchants. After an authorization response is received in response to an authorization request for the transaction, each merchant is billed for the contribution for each such transaction. Thereafter, each receipt for each contribution made by each merchant to the entity is collected. A predetermined time after each such transaction, each merchant is sent a notice as to any difference between the bills sent to the merchant and the contribution receipts received from the entity that are attributable to the merchant.

In another computerized implementation, a process automatically populates one or more databases to allow information to be received, from an issuer, as to a logical address of each account holder to whom the issuer issued an account having an account billing address in a geographic area. The process sends information to each logical address of each account holder conveying each merchant that will contribute to an entity in a geographic area as a function of a currency amount of each transaction conducted between the merchant and the account holder on the account issued by the issuer. A bill for the contribution is then sent to a logical address of each such merchant for each such transaction with each such account holder after an authorization response for the transaction has been received in response to an authorization request for the transaction. Thereafter, receipts for donations made by the merchants to the entity are received. A predetermined time after each transaction, a notice is sent to each such logical address of each such merchant as to a difference between the corresponding bill sent to the merchant and the corresponding receipts for donations received from the entity that are attributable to the merchant.

Another implantation pertains to a system that includes a plurality of merchants conducting transactions on respective accounts issued to respective account holders by respective issuers, wherein the issuer sends an authorization response for the transaction to the merchant through a transaction handler and an acquirer for the merchant in response to an authorization request sent to the issuer from the merchant through the transaction handler and the acquirer. In a computerization of this implementation, a process receives, for each such merchant, information that includes a Merchant Acquirer Password (MAP). The method retrieves, using the MAP, a logical address for an acquirer for the merchant. A request that includes the MAP is sent to the logical address for the acquirer for the merchant. In response to the MAP request, there is received for a Merchant-Identifier (M-ID) for the merchant, a Merchant Logical Address (MLA) for the merchant, and a Merchant Geographic Address (MGA) for the merchant. Using the MGA, a Merchant Affinity-ID is retrieved. Using the Merchant Affinity-ID, there are retrieved a logical address for the Merchant Affinity-ID and an Affinity Donation Rule that includes a time range. A message derived at least in part from the Affinity Donation Rule is transmitted to a logical address of each such account holder associated with an account holder geographic address that corresponds to the MGA for the merchant. For each such transaction, information is received that is derived from the authorization response and includes an account holder ID, the Merchant-ID, a date and time, and a currency amount. Retrieval is made, using the Merchant-ID, of the Merchant Affinity-ID for the merchant and an Affinity Donation Rule for the merchant. Using the Affinity Donation Rule and the currency amount of the authorization response, a derivation is made of an Affinity Donation currency amount that is greater than a predetermined threshold when the date and time of the received information derived from the authorization response for the transaction is within the time range from the date and time that the message derived at least in part from the Affinity Donation Rule that was transmitted to the logical address of the account holder. When the Affinity Donation currency amount is greater than the predetermined threshold, a message is sent to the logical address for the Merchant Affinity-ID that includes the Affinity Donation currency amount and the Merchant-ID, and Affinity Donation Information is sent to the MLA that includes the Affinity Donation currency amount and the Merchant Affinity-ID. In some implementations, however, the merchant will not be responsible for paying the Affinity Donation currency amount unless: (i) that currency amount exceeds the predetermined threshold; and/or (ii) the message derived at least in part from the Affinity Donation Rule had been previously transmitted to the account holder on a date that is not more than the time range from the date of the transaction between that account and the merchant.

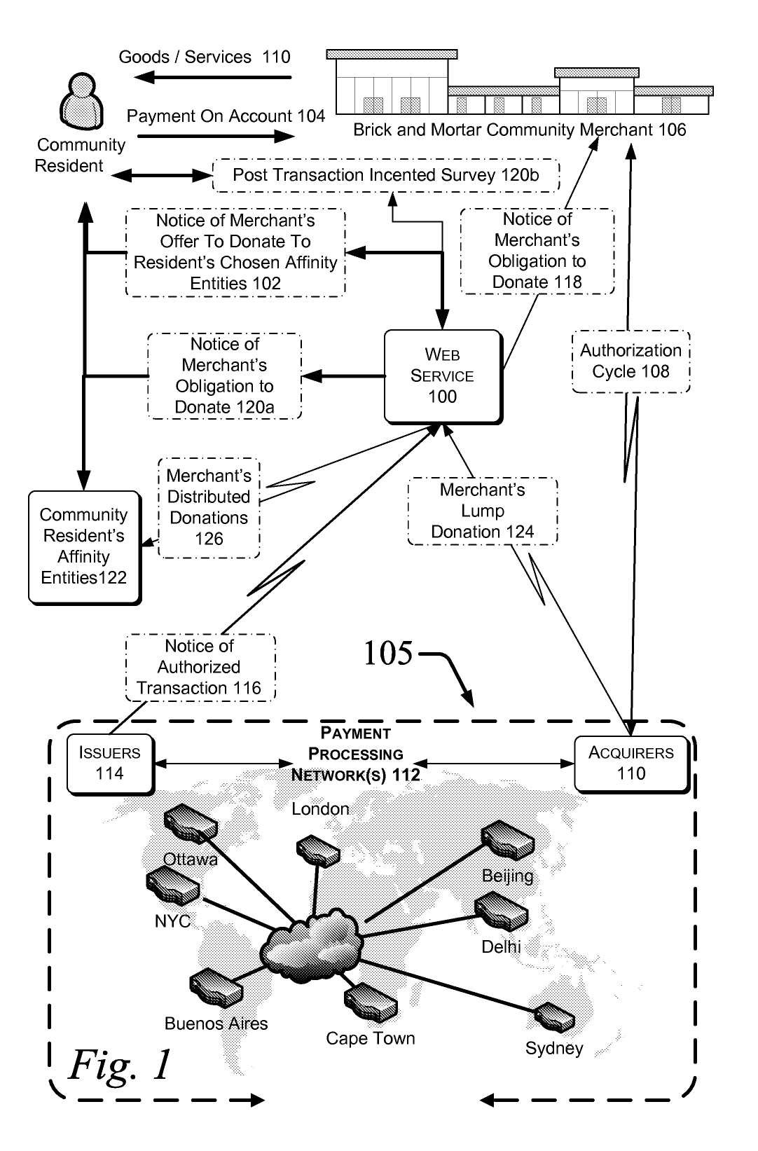

Referring now to FIG. 1, an environment is depicted for a global Acquired Account Payment Processing System 105 as shown. FIG. 1 shows a community resident who is incentivized to transact by way of a merchant's offer 102 to a make a donation in exchange for the community resident purchasing goods and services 110 by the community resident's payment on an account 104 that was issued by an issuer 114 to the community resident. Note that, in some implementations, the merchant sets terms and conditions under which the merchant's donation will be made, while the community resident selects those affinities entities to which the merchant's donations are to be made.

The merchant, who may be operating a brick and mortar store in the community where the community resident resides, inputs data about the transaction on the community resident's account into a Point of Service terminal (POS) 106. The POS, for example, can be a cash register, a web-enabled mobile device (e.g., a tablet computing device), etc. The POS 106 transmits the input data, as part of an authorization request in an authorization cycle for the transaction, to an acquirer 110 for the merchant. Acquirer 110, who can be just one of many entities in the global Acquired Account Payment Processing System 105, sends the authorization request through a payment-processing network 112, as facilitated by one or more transaction handlers, for example Visa Net, to the issuer 112 who issued the account to the community resident. In response to the authorization request, the issuer 112 sends an authorization response at least of portion of which is ultimately sent for delivery back to the merchant's POS 106 by transmissions made in backward directions through the payment-processing network 112 via the merchant's acquirer 110.

If the transaction is authorized by issuer 114, an entity in the global Acquired Account Payment Processing System 105, such as the issuer 114, sends a message 116 containing particulars of the transaction to a Web Service 100 indicating that a transaction on the community resident's account was approved for being conducted by the community resident with the merchant whose offer to donate may have been previously selected by the community resident.

Optionally, the data input into POS 106 can include additional monies received from the customer by the merchant that are also to be donated, via the merchant, to a designated affinity entity 122 (e.g., a charity). In that case, message 116 would also contain these particulars.

Upon receipt of message 116, a donation to the affinity entity 122 by the user's selected merchant is calculated according terms and conditions specified by the merchant.

Web Service 100 retains the derived donation for subsequent audit purposes to insure compliance by each community merchant in its donation commitments to each of the one or more affinity entities or charities. The Web Service 100 may transmit a message containing notice of a donation, or the particularly derived donation, as shown at reference numerals 118-120 to respective logical addresses of the obligated merchant 106, one of more community resident/account holder designed affinity entities 122, and the community resident/account holder—and/or to respective agents thereof. The terms and conditions that obligate the merchant-offeror to make a donation may, but need not, include discounts, rebates, or other monetary or non-monetary incentives. As such, the community resident/account holder is incentivized to purchase from the merchant's store, inter alia, by the merchant's agreement to donate to one of more community resident/account holder designed affinity entities 122.

The affinity entity or charity, which may be selected at the discretion of the community resident/account holder, may be any entity to which the community resident has an affinity, regardless of where it is located or whom it serves. Alternatively, the affinity entity or charity may be limited to those organizations that provide a good and/or service to a community in which both community residences and merchants have an affinity—such as by their common geographic location, as by its geographic location being within a computed commuting time, by one more modes of transportation, that is below a predetermined time threshold. This affinity entity may provide food and clothing to underprivileged families in their common community. This affinity entity, for example, may provide teaching and demonstrations of entrepreneurial skills to community's unemployed or under employed. Another affinity entity may provide venues where sports education can be provided to local competing youth. Yet another affinity entity may provide care and feeding to abandoned domesticated animals, such as pets. The affinity entity may also cultivate desirable citizenship and public policy through offerings of education and entertainment services—whether in person, on-line, or both. Given the foregoing, the reader will understand that the affinity entity can be either a for-profit or a non-profit organization, and may optionally be required to provide a good or a service to a local community to which both merchants and customers in the same community have an affinity, by their common location, to advance and/or promote the community.

In some implementations, each merchant will identify the affinity entity to whom the merchant-offer will make a donation. To identify the affinity entity, a customer identifier, as received by Web Service 100 in message 116, can be used to look up or access information from which can be derived a geographic address in a community where the customer resides. Alternatively, the customer's geographic address can be an address that is associated with an account issued by an issuer to the customer upon which the transaction with the merchant is being conducted. As a still further alternative, the customer's geographic address can be an address specified by the customer as being the address that is to be used for the purpose of determining the customer's community, whereby the customer can self-select their own community by specifying a geographic address in the customer's self-selected community. Similarly, a merchant identifier, also received by Web Service 100 in message 116, can be used to look up or access information from which can be derived a geographic address in a community where the merchant-offer has a brick and mortar store. Alternatively, the merchant's geographic address can be an address that is associated with a merchant acquirer account issued by the merchant's acquirer to the merchant that will receive proceeds from the transaction with the customer that is being conducted. As a still further alternative, the merchant's geographic address can be an address specified by the merchant as being the address that is to be used for the purpose of determining the merchant's community, whereby the merchant can self-select its own community by specifying a geographic address in the merchant's self-selected community. These respective geographic addresses of customer and merchant, whether self-selected or otherwise, when retrieved from one or more network accessible databases, can be compared, using processes, procedures, and methodologies enabled herein, by Web Service 100, from information in or derived from message 116, to determine whether the merchant and its customer have the same local community. By way of example, data in message 116 can include an identifier for the customer, and a database of merchants and their respective merchant-offers can include geographic location information. This geographic location information is matched against the geographic location information for the residence of the customer. Merchant and customer identifiers can be assigned to the merchant and its customer during or prior to any transaction, such as when each are registered with or otherwise sign up for participation with Web Service 100. This registration process can include the collection of physical and logical addresses for each or for their respective agents.

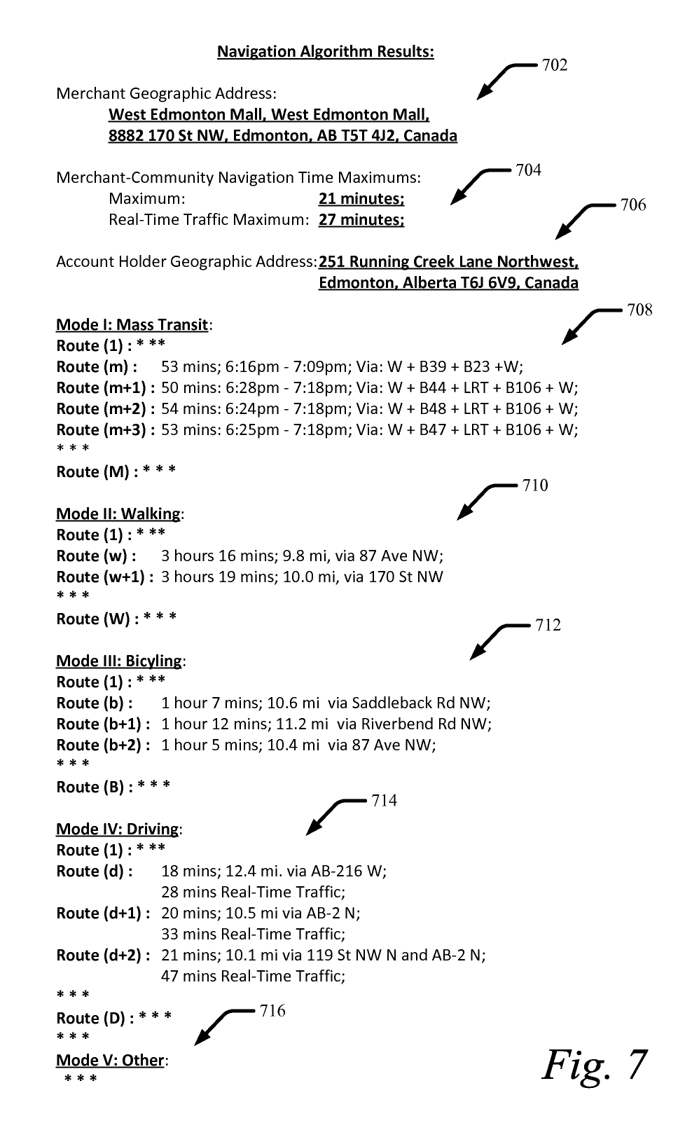

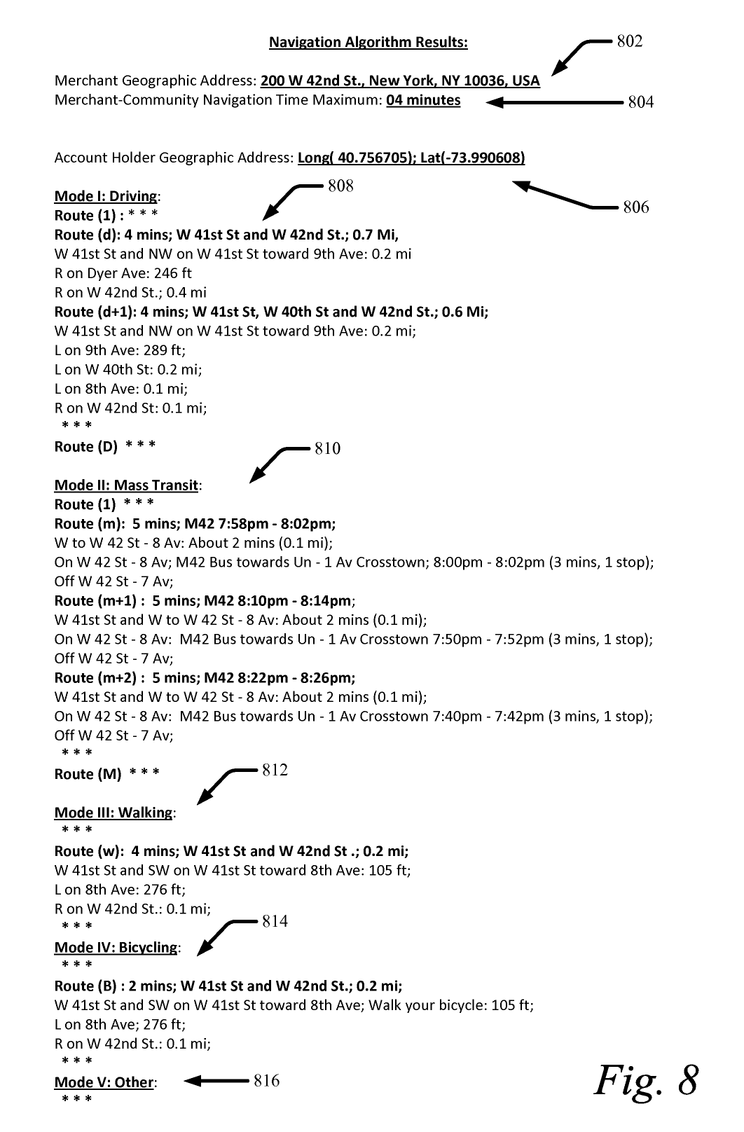

Once physical address information for the merchant-offeror and its customer are known, the local community of each of the merchant and its customer can be determined—in some implementations. Studies show that a significant portion of spending by a consumer is restricted to a region that is proximal to where the consumer resides. Accordingly, it is desirable for a merchant to attract those consumers who reside within the restricted region corresponding to the merchant's geographic location so that the customer can use a mode of transportation to travel from a geographic address of the customer's residence to the merchant's geographic location within a travel time that less than a threshold, as further discussed below with respect to FIGS. 7-8. As such, any such travel time that is less than the threshold might be understood to mean that the merchant-offeror and the customer who is traveling to the merchant-offeror are in the considered to be within the same community or the ‘Merchant-Community’.

Alternatively, the local community determination can be made on any of other different methods, or combinations thereof. Once such method is a political or legal division, that is, the merchant's place of business is determined to be in the same political or legal division as that of its customer's residence, such as the same province, state, county, prefecture, city, city-state, borough, etc. Another such comparison can be whether the merchant's place of business has a governmentally issued postal code that is the same, or within a predetermined proximity, as that of its customer's residence.

Yet another such comparison can be whether the merchant's place of business and its customer's residence are physically proximate within a predetermined factor by any of a variety of measures or combinations thereof. For example, latitude and longitude coordinates might be known for both the merchant's place of business and the residence of its customer. These coordinates can be used to determine whether the linear distance there between is within a predetermined distance to ascertain whether or not the merchant and its customer share the same local community.

As discussed above and for a further alternative, and also further discussed below with respect to FIGS. 7-8, a calculated navigation time algorithm, using any of various different travel methods (e.g., walking, automobile, bicycle, mass transit, etc.), can be used to determine whether the time, using any of one or more modes of transportation, is within a predetermined time limit to ascertain whether or not the merchant and its customer share the same local community, ‘neighborhood’, or Merchant-Community. By way of example, the merchant and its customer might be determined to be within the same local community if the automobile drive time, as determined from one or more databases of contemporary cartographic road system information, to navigate from a geographic address attributed to the attributed to the customer and a geographic address attributed to the merchant is less than a predetermined time threshold (e.g., 17 minutes), with yet another threshold that may be used to weight the navigation time calculations with real time traffic conditions data.

A further alternative implementation will identify the population density of both the merchant's brick and mortar store and the customer's residence. If the population density exceeds a predetermined density, then the merchant and its customer might be determined to be within the same local community if the time to walk, bicycle or take public transportation between the merchant's brick and mortar store and the customer's residence, as determined from one or more databases of contemporary topographic, mass transit, and/or pedestrian cartographic system information, is less than a predetermined time threshold (e.g., 55 minutes). Such implementations may also access databases to consider real time traffic conditions. Rural, industrial, city, and suburban environments will have different population densities, and likely modes of transportation, that correspondingly may have an effect on a travel time from a customer's resident to a merchant's geographic location. A further discussion is given below, in reference to FIGS. 7-8, relative to providing an incentive to customers living close by in exchange for traveling to, and transacting at, a merchant's store.

Still another such comparison can be whether the merchant's place of business and its customer's residence are proximate or are the same according to voting, electoral, or political districts. The district can be determined by an official method, an unofficial method, or a combination of methods. By way of example, measurements known within the political gerrymander sciences can be used, including but not limited to a minimum district to convex polygon ratio, shortest split line algorithm, minimum isoperimetric quotient, etc.

The local community corresponding to that of the merchant and its customer, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owned and leased properties, etc. Given the foregoing, an algorithm might find that the merchant and its customer are members of the same community, not members of the same community, or are both members of more than one of the same communities as determined by the algorithm.

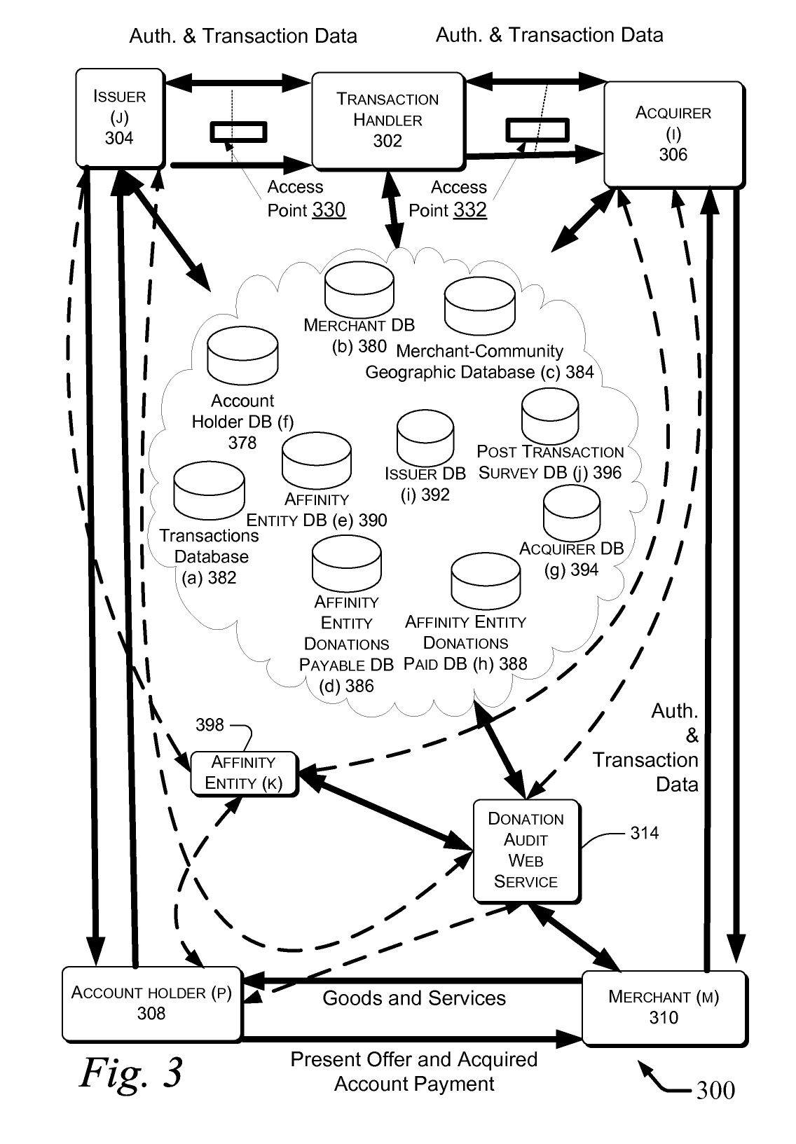

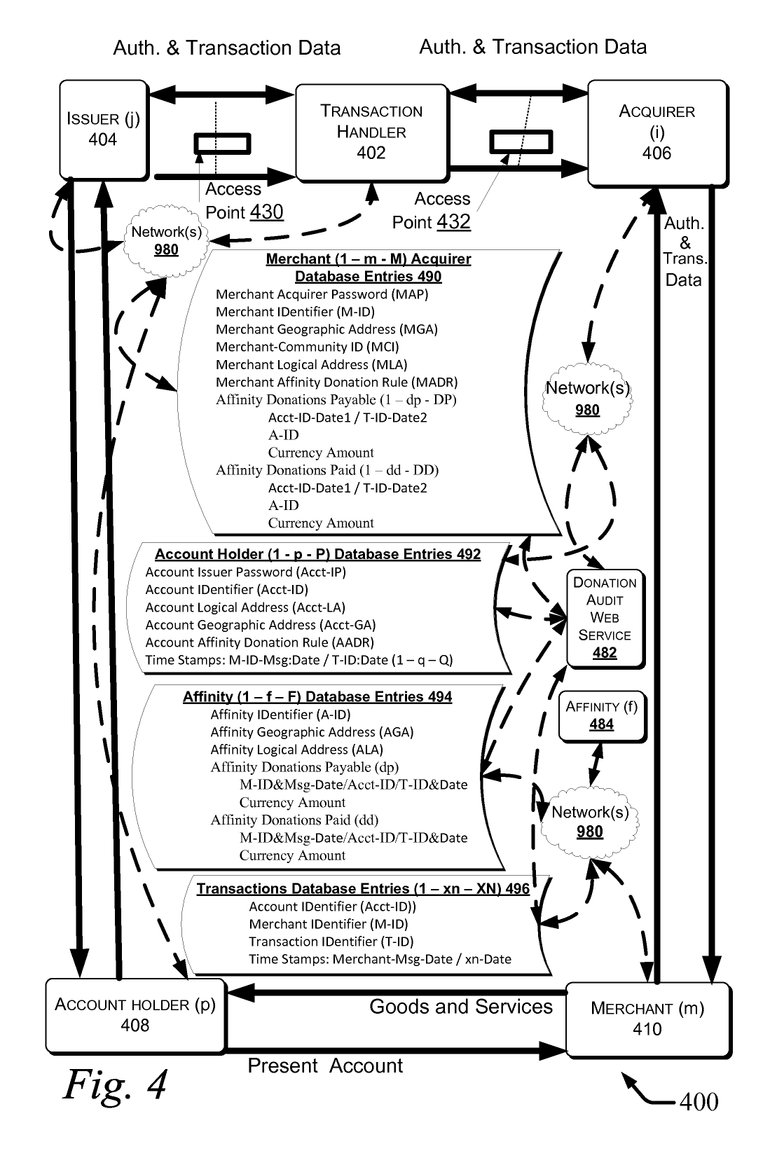

Similar or different algorithms that are used to determine the respective local community of the merchant and its customer can also be used to determine the local community of an affinity entity such as that shown on FIG. 1 at reference numeral 122, or as that shown as an Affinity Entity (k) 398 in FIG. 3, and an Affinity Entity (f) 484 in FIG. 4, as discussed herein below.

In some implementations, if the local community of the merchant, its customer, and an affinity entity that has been selected by the customer or by other methods are the same, then the business rule selected by the merchant will determine the amount of the donation that the merchant will make to the selected affinity entity. In some implementations, the affinity entity to whom a merchant is to make a donation can only be selected by the customer, and not the merchant. In such implementations, the goals or purposes of an affinity entity will not cause tension between the goals or purposes of the merchant or the goals or purposes of customer in that the identity of the affinity entity is unknown to the merchant through its being selected anonymously by the customer. As such, the merchant need not be told or be given any notice, directly or indirectly, as to the identity of the affinity, entity or charity selected the customer with whom the merchant is conducting a transaction. Rather, the merchant might only be told or be given notice to make a single payment of, or period payments to, a single affinity entity who, as trustee or agent, will thereafter make respective disbursements for all registered merchants accordingly to those affinity entities that had been selected by those customers with whom those merchants had conducted transactions.

Various implementations can ensure that a merchant who, by force of reason or conscience, does not want to make a donation to a particular affinity entity or charity, need not do so directly, as any and all merchant donations are made blindly through other avenues or collection points that make all merchant donation disbursements to all affinity entities or charities. Accordingly, each merchant will have notice of its total periodic donations without knowing the identity of the intended recipients, thereby leaving the direction of donations fully within the discretion of the merchants' customers. Note that a limitation can optionally be placed upon the customer's choice of affinity entity or charity such that the choice must be made only among those affinity entities or charities that serve the local community of the merchant, its customer, or both. Such implementations may leave the currency amount of the merchant's donation fully within the discretion of the merchant. Yet another limitation can optionally be placed upon the customer's choice of affinity entity or charity such that the choice must be made only among those affinity entities or charities that are on a pre-designated list of those organizations that are pre-approved by a third party as being available for such selection according to an approval process.

Web Service 100 can use respective identifiers for the merchant and its customer (e.g., account holder) to access and retrieve geographic information for each, and then apply an algorithm to the retrieved geographic information to determine the respective local communities of the merchant and its customer, as discussed above. By way of example, the local community can be progressively granular in nature, such as: 1^{st} the United States of America; 2^{nd} the state of New York; 3^{rd} the portion of New York called “Long Island”; 4^{th} the county of Nassau within the state of New York; 5^{th} a portion of the Nassau County called North Hempstead; and then 6^{th} the specific geographic location of “Port Washington”. This final level of geographic granularity indicates a community in which both merchant and customer are members, neighbors, residents, and/or the like.

The final level of geographic granularity can be used to perform a look-up against one or more databases to which Web Service 100 has access. This access and lookup is used by Web Service 100 to identify: (i) the affinity entity or charity for that community which, in this example, might be the Port Washington Food Bank located in Port Washington, N.Y., which charity might have been specified by the customer; and (ii) the respective identifier of the merchant's business rule (and/or the customer's business rule) that is to be used to make a calculation of the currency amount of the donation that the merchant is to make to the affinity entity or charity for that community. Business rule(s) is/are used with the currency amount of the customer's payment in order to calculate the currency amount of the donation that is to be made by the merchant to the affinity entity or charity for that community. Note that the donation can be directed to a plurality of affinity entities for the local community according to directions that had been previously specified by the customer. For example, the customer may have specified that each merchant donation is to be split evenly, or in specified portions totaling one hundred percent (100%), between five (5) local community affinity entities, for example: (i) a local youth sports team cooperative; (ii) a local charter junior high school; (iii) a local house of worship; (iv) a local political party; and (v) a local for-profit college specializing business entrepreneurialism.

Referring now to FIG. 1, the community resident can take the merchant's conditional offer 102 to the local merchant's brick and mortar store POS 106. After showing the offer 102 to the merchant at the POS 106, the community resident conducts a transaction on an account 104 issued by an issuer to the community resident to pay of the transaction and buy goods and/services 110 received by the community resident.

Note that terms and conditions of the transaction may differ from that of the offer presented by the community resident at the local merchant's brick and mortar store. As such, the merchant's offer to donate might not be specific to a particular good or service, but can be specific as to the entire transaction between the merchant and its customer. By way of example as to this type of offer specificity, the offer may obligate the merchant to make a donation of a certain percentage of the entire currency amount of transaction, or the offer may obligate the merchant to make a donation only if the transaction is conducted at a certain time of day or on a particular day of the week, or only if the currency amount of the transaction exceeds a predetermined amount, or a combination of the foregoing. Other conditions are also permissible.

Although some terms of the offer may differ from some terms of subsequent transactions between the merchant and its customer, nevertheless, the merchant's offer to make a donation to an affinity entity (e.g., a local charity) fundamentally provides an incentive that causes, at least in part, the local community resident to navigate to the local merchant's brick and mortar store, come into the store, shop, and ultimately conduct a transaction that will bring revenue to the local merchant and its community. Advantageously, the absence of specificity in the offer as to a particular good or service allows many implementations to operate without modification to the merchant's input of data about the transaction at the POS 106, without modifications to the POS 106 itself or procedures for its operation, and without modifications to software executing on POS 106.

Optionally, a community resident (e.g., customer) may accept the merchant's offer 102 in advance of going to the POS 106. Such advance acceptance may take place electronically, such as in response to the community resident's electronic receipt of offer 102. Such an electronic acceptance to offer 102 can be by way of a transmission of information from the community resident to the merchant. The transmitted information can include: (i) an identifier for the registered customer who intends to accept the merchant's offer 102; (ii) the calculated distance and/or time for the customer to navigate, using a known mode of transportation, from a geographic location associated with the customer (e.g., home location, work location, vacation location, etc.) to the merchant's brick and mortar store of the POS 106, for instance, by walking, bicycling, automobile and/or mass transit as further discussed below with respect to FIGS. 7-8; (iii) the terms and conditions of the offer including any expiration thereof; (iv) optionally any other information already conveyed to the customer, such as a statement about the donation that the merchant will make to the Affinity Entity(ies) 122 when the customer conducts a timely transaction with merchant; and (v) other unexpired offers or advertisements that may or may not have been conveyed to the customer, terms and conditions of such other offer(s), etc.

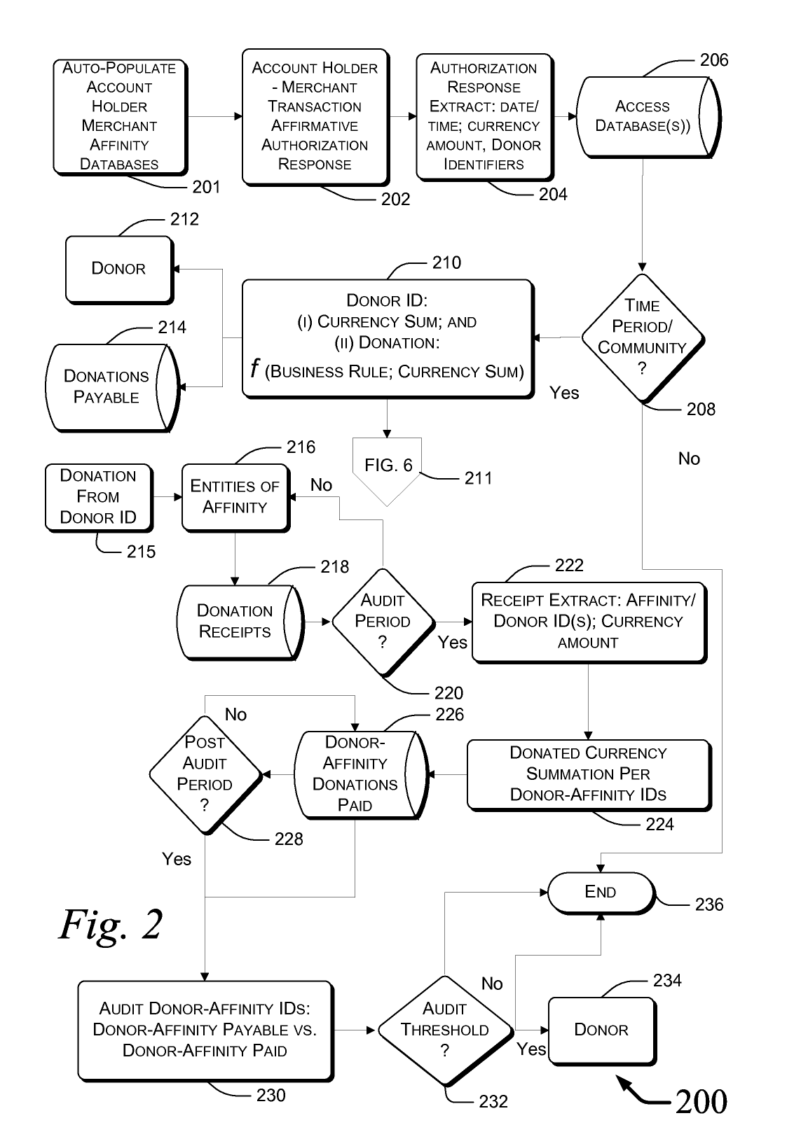

Referring to FIG. 2, a flowchart illustrates a Process 200 that can be performed by a system, such as a system including Web Service 100 in FIG. 1 and/or Donation Audit Web Service 314 seen in FIG. 3, for using local merchants' commitments to make charitable contributions as incentives to local residents to conduct transactions with local merchants.

At step 201, information is automatically populated into one or more databases to facilitate and account for the contributions as further described herein. Consistent with the environments respectively illustrated in FIGS. 1 and 3-4, and prior to step 202 of Process 200, as discussed above with respect to FIG. 1, an account holder offers to conduct a cashless transaction with a merchant on an account issued by an issuer to account holder. The merchant initiates an authorization request to determine whether the issuer, in an authorization response to the authorization request, will authorize the transaction.

Prior to step 202 of Process 200, as discussed above with respect to FIG. 1, a registered local community resident conducts a transaction on an account issued to the resident at a brick and mortar store of a local community merchant. Prior to this transaction, as discussed above with respect to FIG. 1, the registered local community resident may receive one or more such offers 102, either passively and/or actively by request.

At step 202 of FIG. 2, information is received as derived from a positive authorization response originating from an issuer of an account, or its agent, upon which the transaction was conducted by the customer/account holder with the merchant who made offer 102 as describe above with respect to FIG. 1. Data from this information can be extracted at step 204 by a POS such as POS 106 seen in FIG. 1, including, by way of example and not by way of limitation, the date and time of the transaction, a total currency amount to be paid to the merchant at clearing and settlement on the customer's account, respective identifiers for the merchant and customer, etc.

Identifiers retrieved at steps 202-204 can be used to access one or more databases at step 206. The date and time for the transaction can be compared to ensure the non-expiration of the offer made by the merchant to the customer in a query at step 208. While an invalid offer determination ends Process 200 at step 236, Process 200 proceeds to step 210 when the offer is valid as determined at query 208.

At step 210, rules for calculating a the merchant's donation are made for one or more affinity entity recipients via retrieval of information using data acquired in steps 202-204. These calculations can also include steps to use mapping data to calculate the time to travel from a customer's residence to the merchant's location, which time must be lower than a predetermined threshold in order to obligate the merchant to make a donation, as further discussed below with respect to FIGS. 7-8. These calculations can also include steps to access one or more databases as shown at reference numerals 212-214, including transmitting to and/or storing the calculated donations in one or more merchant donor databases 212 and/or in one or more merchant donations payable databases 214.

Subsequent to the acquired transaction on the resident's account as processed in steps 202-214 of Process 200, the local merchant makes the calculated donation to the local affinity entity as shown at step 215. The local affinity entity, as shown at step 216, sends notice of the donation's receipt for storage in one or more databases as shown at step 218.

After a predetermined audit time period has passed as determined by a query at step 220, an audit is conducted to insure compliance by each community merchant in its donation commitments to each of the one or more affinity entities or charities for which prior notice of such donations were provided to the merchant. This audit can include adding up all required donations for each local merchant to each affinity entity or charity as shown at step 222. The donation summation for each local merchant to each affinity entity or charity derived at step 224 is compared to information in one or more databases 226 to ascertain compliance of each merchant with its donation obligations. Stated otherwise, the local merchant has a certain amount of time after a predetermined audit period, as determined at step 228, by which to complete or make all of the merchant's donation obligations to all affinity entities.

Differences between donations paid and donations still payable by each local merchant are calculated at step 230, which differences are subjected to an audit threshold query at step 232. If a local merchant's donations paid is non-compliant with donations still payable, as may be determined by the audit threshold query at step 232, then Process 200 moves to step 234 to notify the local merchant, or its agent, accordingly of its deficiency. Otherwise, affirmative results at query 232 causes Process 200 to terminate at step 236 which may also include notice of compliance being transmitted to each such complaint local merchant, its customers, and/or each of the local affinity entities. Each such notice can be either by way of summary report, donations to respective affinity entities by the merchant, and variations thereof. Note also that progressive summaries of donations can be widely broadcast periodically incident to fundraising campaigns, capital development initiatives, and times of community need, thereby providing social motivation and incentives to an entire community of participating shoppers to help charities simply by purchasing from participating merchants.

In other implementations, Process 200 includes the exaction of data from information derived incident to a positive authorization response for an acquired transaction conducted on a resident's account, such as chronological information pertaining to the transaction including date and time, a currency amount of the transaction, and any other data desired to assist in a proper calculation of the merchant's obligatory donation to affinity entity 216. By way of example, an identifier for the merchant can be extracted, as well as an identifier for the local community resident as offered to the merchant by the same. The account number, by way of non-limiting example, can be a Primary Account Number (PAN) including a Bank Identifier Number (BIN) for a credit or debit card that is kept by the merchant in a ‘card-on-file’ database.

Note that, in various implementations, business rules can be set and used such that obligatory donations to Affinity Entity(ies) 216 can be made by one or more of the following participants in a payment processing system: the account holder, the account holder's issuer, the merchant, the merchant's acquirer, and the transaction handler. Via access to one or more databases at step 206, and by using the merchant and/or account holder identifiers extracted from the information derived from the positive authorization response, more information can be retrieved. Thereafter, database access can retrieve business rules used to calculate one or more donations that are to be made to the charities or affinity entities by one or more donors respectively corresponding to the account holder, the account holder's issuer, the merchant, the merchant's acquirer, and the transaction handler. Each such donation can be a function of the currency amount of the transaction and the retrieved business rule(s).

In some implementations, donations, per extracted donor IDentifier (ID), are made for those transactions that occur during a predetermined time-period and, optionally, within a predefined geographic location as determined by a query (not shown). If the result regarding a community, geography, or neighborhood query is affirmative, process 200 moves to step 210 where the donations that are to be made by the donor participants in the payment processing system are calculated as a function of the respective business rules. Otherwise, no donation is made and process 200 terminates at step 236. Stated otherwise, in such implementations, Process 200 is intended to obligate a local merchant to make a donation to a local affinity entity (e.g., a local charity) when a local resident conducts a transaction at the local merchant's brick and mortar store in the same community where the local resident resides. Note that the terms ‘local’, ‘resident’, ‘residential’, ‘community’, neighborhood, and the like, can be alternatively defined as described elsewhere herein.

As in other implementations described above, donations calculated at step 210 are communicated to the local merchant donor, or its agent, at step 212, and are stored in a donations payable database 214. Thereafter, donations 215 are received at affinity entities 216 at step 215 from donors identified by either respective donor IDs, which can be the identifier for the merchant or for other payment processing system participants. Donations received are stored in donation receipts database 218. Data from donations that are made by donors via communication to affinity entities 216 during an audit period, as determined at query 220, is extracted at step 222. The donation-related data that is extracted at step 222 can include the donor ID, and the currency amount of the donation. During the audit period, a sum of donations to each affinity entity 216 made by each local merchant donor for the audit period is calculated and stored in a donor-Affinity Entity donation paid database 226. After a predetermined time period, an audit period begins, as determined by query 228. During the audit time period, differences in donations paid are compared to donations payable for each donor at step 230. Differences exceeding a predetermined audit threshold, as determined by query 232, are communicated to the respective local merchant donors, or their respective agents, at step 234. Of course, the charitable audit functions, such as have been described above, can be performed by an agent of any donor and/or of a loyalty system organization charged with implementing all or portions of process 200. Such an auditing agent can be, by way of non-limiting example, a certified public accountancy agency, a non-government regulatory agency, a governmental agency, and the like.

As discussed above with respect to various implementations, a donation mechanism can be set up such that the merchant-donor makes blind donations, either directly or indirectly, to a single donation disbursement entity who in turn disburses the donations to those affinity entities selected by the customers of the merchant-donor. This donation mechanism provides neither knowledge nor notice to merchant-donor as to the identities of its donation recipients, thereby avoiding circumstances that force a merchant, by virtue of its prior commitment, to donate to a local community affinity entity or charity whose role or purpose is inimical or otherwise repugnant to the merchant-donor. As such, the donation mechanism leaves the direction of the merchant's donation fully within the discretion of the customer, limited only, in some implementations, by the restriction that the customer can only select from among those affinity entities or charities that serve the local community that is in common to both the customer and the merchant-donor, while leaving the actual currency amount of the donation fully within the discretion of the merchant-donor.

Referring now to FIG. 3, an exemplary process 300 is depicted of a particular financial transaction system, such as may be described as an open loop system, in which an account holder (p) 308 conducts a financial transaction with a Merchant (m) 310. By way of example, the Account Holder (p) 308's financial transaction with the Merchant (m) 310 may have been incentivized by the Merchant (m) 310's agreement to make a donation to an Affinity Entity (k) 395 in the local community as defined by the Merchant (m) 310 through an ad incentive which, optionally, can be communicated to Account Holder (p) 308, whether requested or not.

In FIG. 3, by way of explanation for the nomenclature of reference numerals used and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer ‘c’ can have a value from 1 to C, etc. As such, drawing elements 304-310 and 378-394, and 398 in FIG. 3 are illustrated with a block, but indicate one or more elements can be present. For example, Issuer (j) 304 is one of a possible plurality of issuers, where j may range from 1 to a large integer ‘J’.

Account Holder (p) 308 presents an account bearing payment device to a Merchant (m) 310 as tender for a financial transaction such as a purchase of goods and services. As part of the transaction, the Account Holder (p)'s 308 payment device can be a credit card, debit card, prepaid card, cellular telephone, Personal Digital Assistant (PDA), etc. Those of skill in the art will recognize that other financial transactions and instruments other than credit cards may also be used, including, but not limited to, a prepaid card, a gift card, a debit card, a token equivalent of an account as communicated via cellular telephony, near field communications, and the like. For purposes of illustration and explanation, however, reference will be made to a credit card.

The payment device can be manually keyed into a POS or can be read by a reader operated by the Merchant (m) 310, whereupon account information is read from the payment device and a request for authorization is transmitted to the Merchant (m) 310's Acquirer (i) 306. Each Acquirer (i) 306 is a financial organization that processes credit card transactions for businesses, for example merchants, and is licensed as a member of a Transaction Handler 302 such as a credit card association (i.e., Visa Inc., MasterCard, etc.) As such, each Acquirer (i) 306 establishes a financial relationship with one or more Merchants (n) 310.

The Acquirer (i) 306 transmits the account information to the Transaction Handler 302, who in turn routes the authorization request to the account holder's issuing bank, or Issuer (j) 304. The Issuer (j) 304 returns information via an authorization response to the Transaction Handler 302 who returns the information to the Merchant (m) 310 through the Acquirer (i) 306. The Merchant (m) 310, now knowing whether the Account Holder (p) 308's credit card account is valid and supports a sufficient credit balance, may complete the transaction and the Account holder (p) 308 in turn receives goods and/or services in exchange. Most credit card associations instruct merchants that, after receiving an affirmative authorization response, the detailed credit card account information obtained by a point of service terminal (e.g., such as via a magnetic stripe scanner) must be deleted.

To reconcile the financial transactions and provide for remuneration, information about the transaction is provided by the Merchant (m) 310 to Acquirer (i) 306, who in turn routes the transaction data to the Transaction Handler 302 who then provides the transaction data to the appropriate Issuer (j) 304. The Issuer (j) 304 then provides funding for the transaction to the Transaction Handler 302 through a settlement bank. The funds are then forwarded to the Merchant's (n) 310 Acquirer (i) 306 who in turn pays the Merchant (m) 310 for the transaction less a merchant discount, if applicable. The Issuer (j) 304 then bills the Account holder (p) 308, and the Account holder (p) 308 pays the Issuer 304 with possible interest or fees.

Also shown in FIG. 3 are one or more Affinity Entities (k) 398 and a Donation Audit Web Service 314 that implement processes by which donations to the one or more Affinity Entities (k) 398 from various donors, for instance, any Issuer (j) 304, an Merchant (m) 310, any Acquirer (i) 306, and the Transaction Handler 302. Donation Audit Web Service 314 implements processes for the auditing of donations to the one or more Affinity Entities (k) 398. The Donation Audit Web Service 314 has access to information resources within the following databases: Account Holder databases 378; Merchant databases 380; Transaction databases 382; Merchant-Community Geographic databases 384; Affinity Entity Donations Payable databases 386; Affinity Entity Donations Paid databases 388; Affinity Entity databases 390, issuer databases 392, acquirer databases 394, and post transaction survey databases 398.

By way of example, and not by way of limitation, Merchant-Community Geographic databases 384 may include construction of local, geographic, residential or community associations between merchants and their customers using factors such as geographic, political, demographics, navigational algorithms using local transportation modes that apply data for cartographic and geopolitical regions, urban population constituencies, rural population constituencies, industrial population constituencies, suburban population constituencies, planned communities, population density, cultural divides, racial population constituencies, census statistics, socio-economic factors, and combinations thereof.

As shown in FIG. 3, Databases 378-396 can be connected by one or more private or public networks, virtual private networks, the Internet, or by other means known to those skilled in the art. Moreover, not every entity seen in FIG. 3 at reference numerals 308, 310, 314 and 398 must necessarily have real time, uninterrupted access to any or all of the Databases 378-396. Each such Database 378-390 can assign, read, write, and query permissions as appropriate to the various entities. For example, a Merchant (m) 310 may have read access to the one or more Transactions Databases 382.

Each Transactions Database (a) 382 can be designed to store some or all of the transaction data originating at the Merchants (n) 310 that use a payment device for each transaction conducted between an Account holder (p) 308 and the Merchant (m) 310. The transaction data can include information associated with the account of an Account holder (p) 308, date, time, and an identifier sufficient to determine a physical geographic location where the transaction took place, among other more specific information including the amount of the transaction. The database can be searched using account information, date and time (or within proximity thereof), or by any other field stored in the database.

The Transactions Database (a) 382 is also designed to store information about each Merchant (m) 310, where the information can include a unique identification of each Merchant (m) 310, an identifier for each point of sale device in use by the Merchant (m) 310, and a physical geographic location of each store of the Merchant (m) 310.

Also included in the Transactions Database (a) 382 is account information for payment devices associated with Account holder (p) 308, such as part or all of an account number, unique encryption key, account information, and account name of an account holder who is registered to participate in a system in which donations can be made to each Affinity Entity (k) 398 as per rules stored in Merchant Database (b) 380. After registering to participate in the donation system, an Account holder (p) 308 initiates a qualifying purchase transaction with a Merchant (m) 310 by presenting a payment device (not shown) to the Merchant (m) 310. The payment device is typically presented at the Point Of Service terminal (POS) at which data thereon is read. Certain transaction information is transmitted from the POS (e.g., card track data) in route to the Merchant's (n) 310 Acquirer (i) 306. The transaction information can include account information, account name, transaction balance, transaction time, transaction date, and transaction location. Sensitive information includes information such account number and account holder name that identify and associate a particular account with a particular account holder. This transaction information may be transmitted via a less secure communication medium. In addition, a transmission of transaction data may occur with weak or no encryption between two or more points from the point of origin, such as the point of sale device at the Merchant (m) 310, and the ultimate destination, such as the Acquirer (i) 306. These points can include, without limitation, from the reader at the POS, the POS at the Merchant (m) 310 and a network router or computer that is connected to a network but is housed and maintained by the Merchant (m) 310 and between the Merchant (m) 310 and the Acquirer (i) 306. The communication channel could be Ethernet, wireless internet, satellite, infrared transmission, or other known communication protocols. Some or all of the transmission may also be stored for record keeping, archival or data mining purposes with little or no encryption. For example, the Merchant (m) 310 may store transaction data, including certain account information in the Merchant's (n) 310 accounts on file database for reuse later.

During a transaction conducted by Merchant (m) 306 on an account issued by Issuer (j) 304 to Account Holder (p) 308, information relating to the qualifying purchase is retrieved from the POS at Merchant (m) 306. The transaction information is comprised of account information together with other information about the transaction itself: time, date, location, value, etc. Certain parts of the transaction information are considered sensitive information including, without limitation, account number, credit card verification number, and account name.

For the Account Holder (p) 308 to donate to each Affinity Entity (k) 398 as may have been previously specified, the Account Holder (p) 308's Issuer (j) 304 can pay the Affinity Entity (k) 386 and apply a debit in that currency amount on the Account Holder (p) 308's periodic revolving credit statement. The Account Holder (p) 308, upon receipt of the statement, can thereafter make a total payment to the Issuer (j) 304 of the currency amount of the donation that appears as a debit on the statement along with the other credit charges that also appear on the Account Holder (p) 308's statement.

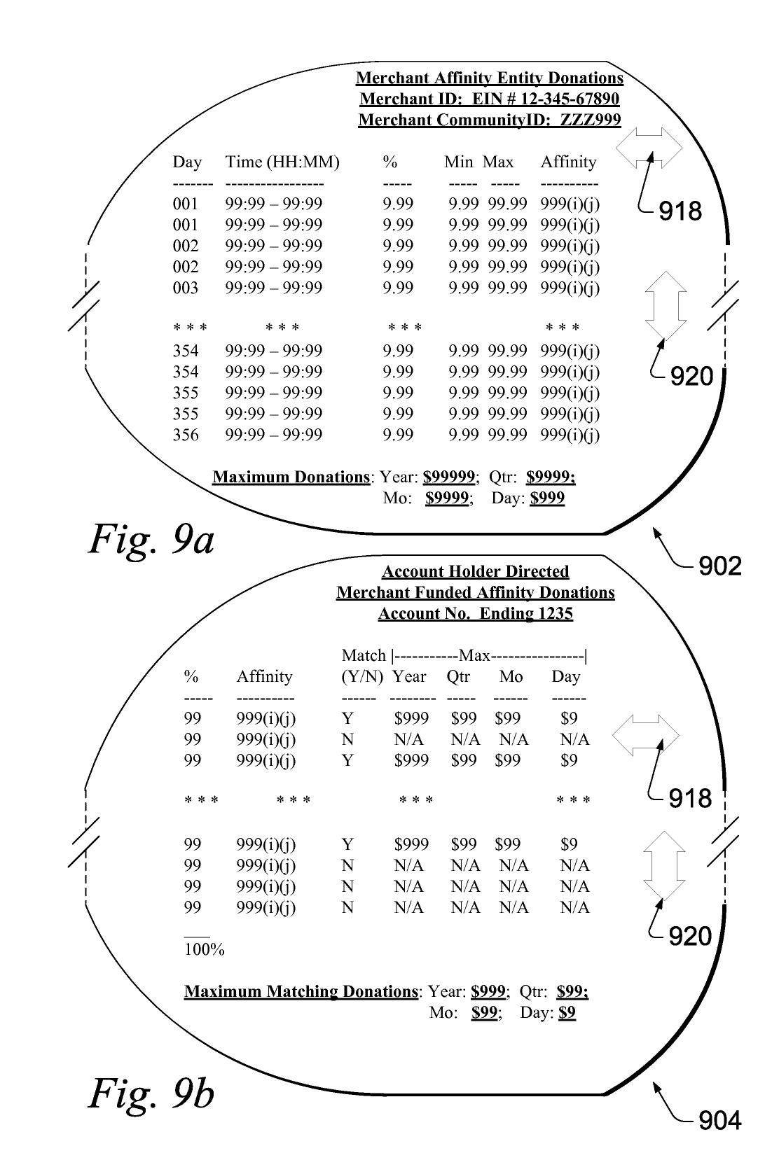

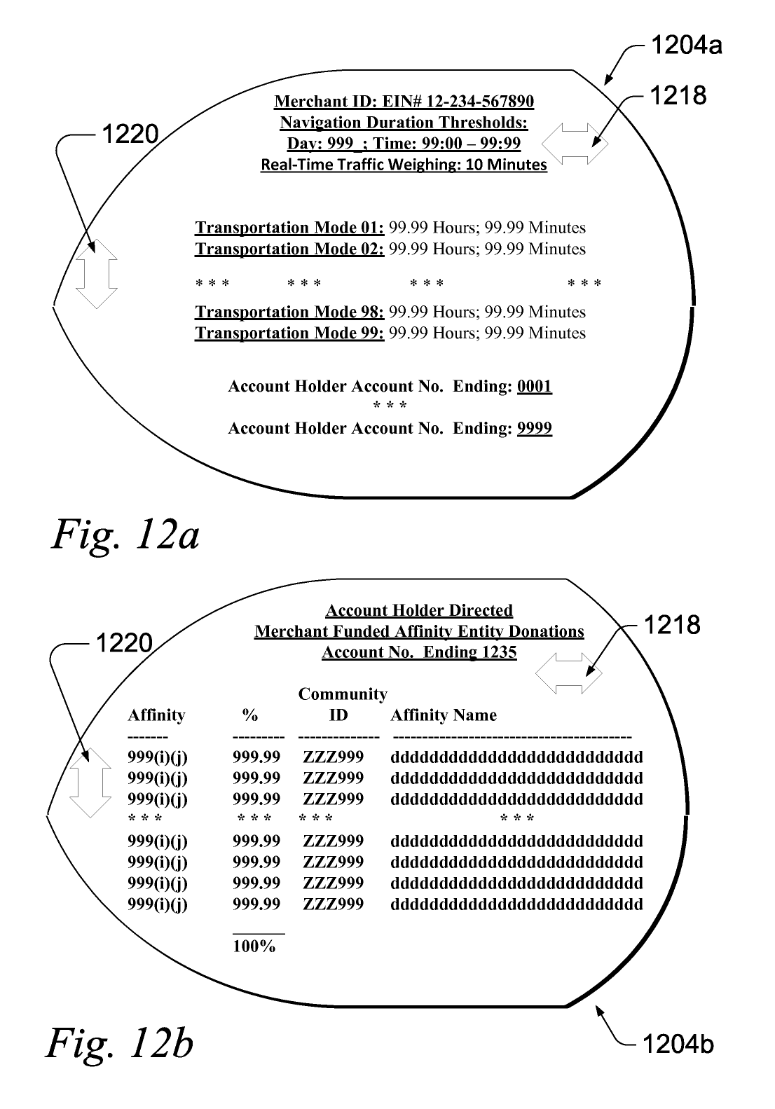

As discussed below with respect to FIGS. 9a-9b and 12a-12b, both the Account Holder (p) 308 and the Merchant (m) 310 can change or disable a donation commitment at any time by accessing a server that serves web pages where respective user interfaces are provided. Thus, charitable donation commitments can be enabled or disabled using real time user interfaces. By way of example, and not by way of limitation, such servers can be hosted by the Donation Audit Web Service 314 seen in FIG. 3.

In various implementations, Donation Audit Web Service 314 seen in FIG. 3 receives information that confirms such a timely transaction between the customer and the merchant by way of receiving information derived from an authorization response for the transaction. As more fully described elsewhere herein with respect to FIG. 3, the information in the authorization response is typically generated by an Issuer (j) 304 who issued an account to the Account Holder (p) 308 (e.g., the customer or mobile device user) on which the timely transaction with the Merchant (m) 310 was conducted. A positive authorization response reflects the Issuer (j) 304's approval of the transaction on the account issued to Account Holder (p) 308. Stated otherwise, and as shown in FIG. 3 and discussion herein below, Donation Audit Web Service 314 receives the information derived from an authorization response from an acquired account payment processing system (i.e., see Ref. Num. 105 in FIG. 1), where each of the Issuer (j) 304, the Account Holder (p) 308, and the Merchant (m) 310 operate in the acquired account payment processing system.

Once confirmation has been received by Donation Audit Web Service 314 that a timely transaction has taken place been the merchant who made the offer and the customer who selected and confirmed that offer, a calculation is made of an amount of a donation that is to be made by the merchant-offeror according to terms of the offer. By way of example, the terms of the offer to make the donation to the community affinity entity or charity 398 may have been previously input for storage in Merchant DBs 380 by way of the merchant's user interface provided by an application executing on a computing device, such as in conjunction with screen shots seen in FIGS. 9a and/or 12a as described herein below. To give notice of the donation obligation that has arisen, the calculated donation can be sent in one or more transmissions from Donation Audit Web Service 314 to one or more logical addresses such as: (i) the Merchant (m) 310; (ii) the Affinity Entity 398; (iii) the Customer or Account Holder (p) 308—or to respective agents thereof. Optionally, information that identifies the Affinity Entity 398 and/or (iii) the Account Holder (p) 308 can be included in any such transmission.

Where the Affinity Entity 398 to which the Merchant (m) 310 is obligated by the timely transaction to make a donation is specified by the Account Holder (p) 308 (e.g., such as by use of a user interface having screen shots such as are seen in FIGS. 9b and 12b, respectively), the identity of the Affinity Entity 398 need not be communicated to the Merchant (m) 310. Rather, the Merchant (m) 310 can make a blind donation of the calculated amount to a third party for distribution to the Affinity Entity 398 in the Account Holder (p) 308's residential community. By such blind, albeit obligatory, merchant donations, conflicts and disagreements between Account Holder (p) 308 and Merchant (m) 310 as to right and proper objects of charity or affinity to the community can be avoided. As such, the Account Holder (p) 308 will transact with community Merchants 310 by way of incentives from the community Merchants 310 that they will donate to the Account Holder (p) 308's favorite charity (e.g., Affinity Entity 398), though the charity may not be the Merchant (m) 310's favorite charity, or even a desirable charity, in that community. Nevertheless, the Merchant (m) 310 has received the benefit of customers' foot traffic inside the merchant's local brick and mortar store, as well as the benefit of transactions with some of those customer who enter the merchant's brick and mortar store, where each such benefit is realized by the merchant's offer to make a donation to the customer's favorite charity(ies) if a timely transaction occurs subsequent to the merchant's offer.

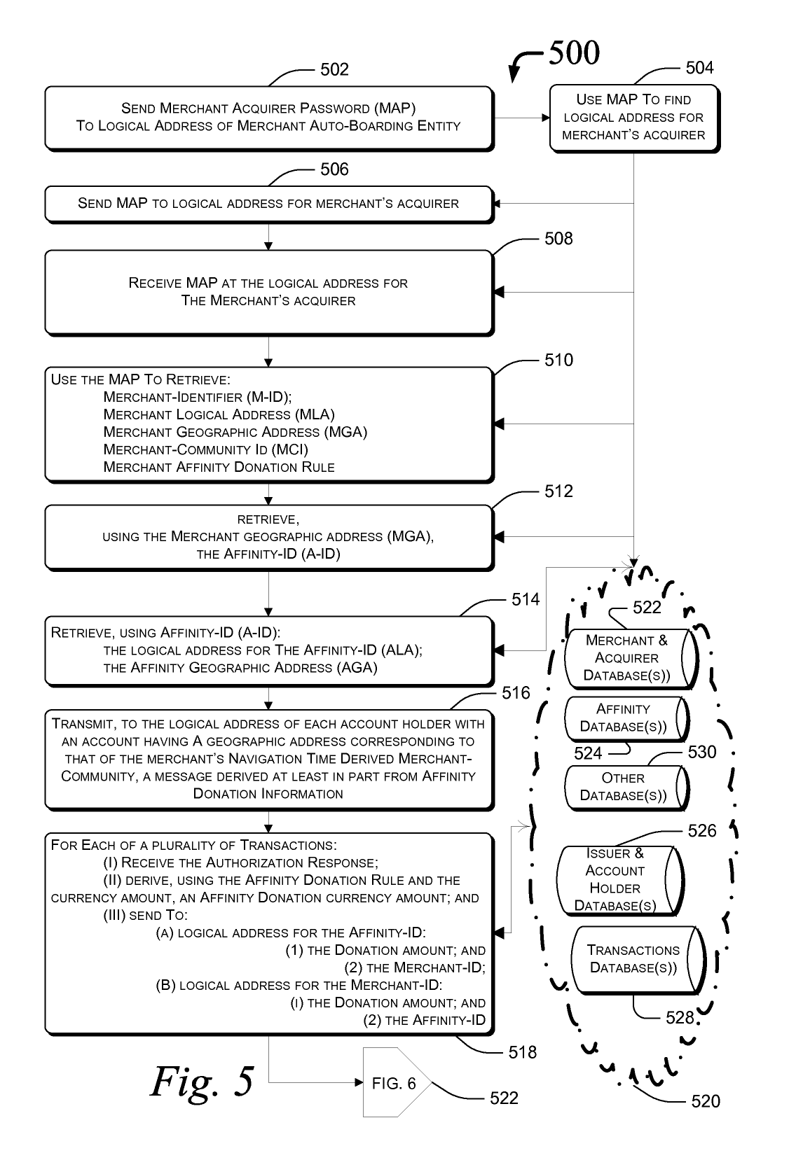

Referring to FIGS. 4-5, a flowchart illustrates an exemplary process 500 in FIG. 5 for making contributions incident to transactions in a cashless payment processing system seen in FIG. 4. Process 500 is enabled, at least in part, via access to one or more entries in one or more databases in communication via one or more networks 520. At step 502, a Merchant Acquirer Password (MAP) is sent to a logical address of a merchant automatic loyalty boarding entity. At step 504, the merchant automatic loyalty boarding entity uses the MAP to access one or more databases 520 to locate a logical address for the merchant's acquirer (Acquirer (i) 306).

At step 506, the merchant automatic loyalty boarding entity sends a transmission that includes the MAP to the logical address for the merchant's acquirer, which is received at step 508. In response to receiving the MAP, at step 510, the merchant's acquirer uses the MAP to access one or more databases 520 so as to retrieve therefrom a Merchant-Identifier (M-ID) for the merchant, a Merchant Logical Address (MLA) for the merchant, a Merchant Geographic Address (MGA) for the merchant, a Merchant-Community Identifier (MCI) for the merchant, and a Merchant Affinity Donation Rule for the merchant. By way of non-limiting example, a database has a plurality of Merchant Acquirer Database entries 490 as shown in FIG. 4. Each such entry 490 includes, for one Merchant (m) 410, a MAP, as well as a Merchant IDentifier (M-ID), a Merchant Geographic Address (MGA), a Merchant Logical Address (MLA), a Merchant-Community Identifier (MCI), a Merchant Affinity Donation Rule (MADR). Optionally, a Merchant Commodity Code (MCC) can also be kept for one or more such merchants. Note also that each entry 490 can have one or more sub-entries (dp) and (dd) for Affinity Donations that are both Payable and Paid, respectively, and where ‘dp’ and ‘dd’ are integers having a value from 1 to ‘DP’ and ‘DD’, respectively. By way of non-limiting example, each Affinity Donation Payable, and each Affinity Donation Paid, in one entry 490 can include: (i) the date that the Account Holder (p) 408 (Acct-ID) was sent an Affinity Donation Message from Merchant (m) 410 (M-ID); (ii) the date that Account Holder (p) 408 (Acct-ID) conducted the transaction with the Merchant (m) 410 (M-ID); (iii) the identifier of the entity of affinity, Affinity (f) 484, (A-ID) to whom the donation is to be made by the Merchant (m) 410; and (iv) the currency amount of that donation (Currency Amount).

By way of example, each merchant can have an initial, auto-boarded, Merchant-Community Identifier (MCI). This auto-boarded MCI can be predetermined, for instance, according to the population density of a geographic address with which the merchant is associated. Thereafter, the merchant can later modify the auto-boarded MCI using a user interface as discussed herein below. The MCI for the merchant can be defined by a maximum time that a customer needs to travel from the residence of the customer to a geographic location attributed to the merchant. The merchant's MCI can be compared to the travel time from the residence of each customer who transacts with the merchant such that the merchant will not be obligated to donate one or more customer selected entities if the customer's travel time, by one or more modes of transportation, as derived by any of a variety of navigation time algorithms using available cartographic data, which data may be weighted by real time travel and travel conditions, exceeds the merchant's MCI. As such, the merchant's MCI attempts to incent customers who live close by and are therefore most likely to transact with the merchant, as further discussed below with respect to FIGS. 7-8.

At step 512, the MAG is used to access one or more databases 520 so as to retrieve therefrom the Affinity-ID (A-ID). The A-ID corresponds to an entity having an affinity to which a merchant and/or an account holder belong. The affinity can be a community, such as a geographic community, to which the merchant and/or the account holder belong. At step 514, the A-ID is used to gain access one or more databases 520 and retrieve information therefrom, such as by sending transmissions that include the A-ID to logical addresses that include, for instance, the Affinity-ID (A-ID) and the Affinity Geographic Address (AGA). By way of non-limiting example, a database has a plurality of Account Holder (p) database entries 494 as shown in FIG. 4. Each entry 494 can include, for each Affinity (f) 484, an Affinity IDentifier (A-ID), an Affinity Geographic Address (AGA), and an Affinity Logical Address (ALA). Note also that each entry 494 can have one or more sub-entries (dp) (dd) for Affinity Donations that are both Payable and Paid, respectively, and where ‘dp’ and ‘dd’ are integers having a value from 1 to ‘DP’ and ‘DD’, respectively. By way of non-limiting example, each Affinity Donation Payable, and each Affinity Donation Paid, in one entry 494 can include: (i) the date that the Account Holder (p) 408 (Acct-ID) was sent an Affinity Donation Message from Merchant (m) 410 (M-ID); (ii) the date that Account Holder (p) 408 (Acct-ID) conducted the transaction with the Merchant (m) 410 (M-ID); (iii) the identifier of the Account Holder (p) 408 (Acct-ID) conducting the transaction with the Merchant (m) 410 (M-ID); (iv) the identifier of the Merchant (m) 410 (M-ID) conducting the transaction with the Account Holder (p) 408 (Acct-ID); (v) the identifier of the transaction (T-ID); and (vi) the currency amount of that donation (Currency Amount).

At step 516, logical addresses respectively corresponding to account holders are sent messages containing information as to the merchants' intentions to make contributions to one or more entities having an affinity, for instance, to the account holder and/or the merchant. By way of non-limiting example, a transmission is made to the logical address of each account holder with an account having a geographic address corresponding to the geographic address of the merchant (e.g., the customer's travel time does not exceed the merchant's MCI as further discussed below with respect to FIGS. 7-8), where the message sent to the account holder is derived at least in part from affinity donation information.

The affinity donation information can include an identification of the entity to which the merchant will make a donation, which donation can be a function, at least in part, of the currency amount of a transaction conducted between the account holder and the merchant on an account issued by an issuer to the account holder. The account holders can be so contacted by access to, and use of information in, a database having a plurality of Account Holder (p) Entries 492 as seen in FIG. 4. The message that is sent to the account holder in step 516 can include the non-monetary consumer incentive that merchant's donation will be good for the community to which the account holder and/or the merchant have an affinity, thereby inducing the account holder's loyalty to the merchant.

By way of non-limiting example, each Account Holder (p) Database entry 492 can include, for each Account Holder (p) 408, an account Issuer Password (Acct-IP), and an Account IDentifier (Acct-ID), an Account Logical Address (Acct-LA), an Account Geographic Address (Acct-GA), and an Account Affinity Donation Rule (AADR). The Account Holder (p) 408 can supply its Acct-IP, as well as each of its Acct-IDs for use of the Merchant (m) 410 and/or the merchant's Acquirer 406 so that the Account Holder (p) 408 will be able to receive messages about each Merchant (m) 410 who will make a contribution to an entity with whom the Merchant (m) 410, the merchant's Acquirer (i) 406, and/or the Account Holder (p) 408 has an Affinity (f) 484. Note also that each entry 492 can have one or more sub-entries (q), where ‘q’ is an integer from 1 to Q, Each subentry (q) for entry 492 can include: (i) the date that the Account Holder (p) 408 (Acct-ID) was sent an Affinity Donation Message from Merchant (m) 410 (M-ID); (ii) the date that Account Holder (p) 408 (Acct-ID) conducted the transaction with the Merchant (m) 410 (M-ID); and (iii) the currency amount of that donation (Currency Amount). Having retrieved various data stored in one or more databases seen in FIGS. 3-6 as pertains to each Merchant (m) 410 and each Account Holder (p) 408, corresponding fields can be automatically populated (i.e., boarded) for storage in records of particular files in one or more of the databases seen in FIGS. 4-5. After the auto-population or ‘boarding’ of these fields from data in databases so accessed and retrieved, these fields can be deleted, completed, updated, or left unaltered, as will be more particularly discussed below with respect to FIGS. 9a and 12a. In summary, Merchants 410, which can be small or medium sized businesses, can have relevant data automatically input or ‘boarded’ on their behalf, thereby offloading management and participation burdens of a non-monetary consumer incentive program that encourages the Account Holders 408's loyalty to Merchants 410 because their donations to each affinity (f) 484 will be good for those communities to which the Account Holders 408 and/or the Merchants 410 have an affinity.

The account holders, having received and been incented by the affinity donation messages, will begin to transact with the merchants. Thereafter, at step 518, for each of a plurality of such transactions, an Authorization Response is received. Information in the Authorization Response will be examined to determine whether the transaction was conducted by an Account Holder (p) 408 who had previously received an affinity donation message from a Merchant (m) 410 on a date that was within a predetermined time range from the date of the transaction. This examination will be used to determine whether the Merchant (m) 410 is obligated to make a donation to an affinity (f) 494 that will be good for a community to which the Account Holder (p) 408 and/or the Merchant (m) 410 has an affinity.

The affinity donation information can include an identification of the entity to which the merchant will make a donation, which donation can be a function, at least in part, of the currency amount of a transaction conducted between the account holder and the merchant on an account issued by an issuer to the account holder. The account holders can be so contacted by access to, and use of information in, a database having a plurality of Account Holder (p) Entries 492 as seen in FIG. 4.

A transaction database entry (n) 496 is stored for each such Merchant (m) 410 who is determined to be obligated to make such a donation to the affinity (f) 484, where ‘n’ is an integer from 1 to N. Each transaction database entry (n) 496 can include: (i) the Account IDentifier (Acct-ID) such a Primary Account Number or PAN of the Account Holder (p) 408; (ii) a Merchant IDentifier (M-ID) for the Merchant (m) 410; (iii) an IDentifier for the transaction (T-ID); (iv) the date (Merchant-Msg-Date) that the Account Holder (p) 408 (Acct-ID) was sent an Affinity Donation Message from Merchant (m) 410 (M-ID); and (v) the date (xn-Date) that Account Holder (p) 408 (Acct-ID) conducted the transaction with the Merchant (m) 410 (M-ID).

FIG. 4 shows, by double headed arrows, authorization and transaction data movement between and among Issuer (j) 404, Transaction Handler 402, Acquirer (i) 406, and Merchant (m) 410, in which Account Holder (p) 408 offers to conduct a cashless transaction with Merchant (m) 410 on an account issued by Issuer (j) 404 to Account Holder (p) 408. Merchant (m) 410 initiates an authorization request to determine whether the Issuer (j) 404, in an authorization response to the authorization request, will authorize the transaction.

By access to, and examination of, various database entries 490-496, the determination can be made as to whether the cashless transaction was conducted by an Account Holder (p) 408 who had previously received an affinity donation message from a Merchant (m) 410 on a date that was within a predetermined time range from the date of the transaction. If this examination finds that this is true, then a derivation will be made, using the Affinity Donation Rule and the currency amount in the Authorization Response, of an Affinity Donation currency amount. Optionally, the Affinity Donation Rule may dictate that no donation will be made unless the currency amount in the Authorization Response is large enough to justify that the donation.

Once the Affinity Donation currency amount has been derived, a message will be sent to the logical address for the Affinity-ID that includes both the derived Affinity Donation currency amount and, optionally, the Merchant-ID. A message will also be sent to the logical address for the Merchant-ID that includes both the derived Affinity Donation currency amount and the Affinity-ID. A pairing of these messages can be audited to ensure that the merchant's expected contributions to the entity of affinity will be properly paid by the merchant or an agent thereof. By way of example, FIG. 1 illustrates a method for one implementation of such an audit process. By way of non-limiting example for an exemplary audit process, Merchant Acquirer Database 490 shows allotment for a plurality of Affinity Donations Payable (for an M-ID and corresponding currency amount) and Affinity Donations Paid (for an M-ID and corresponding currency amount), and Affinity Database 494 shows allotment for a plurality of Affinity Donations Payable (for an M-ID and corresponding currency amount) and Affinity Donations Paid (for an M-ID and corresponding currency amount).

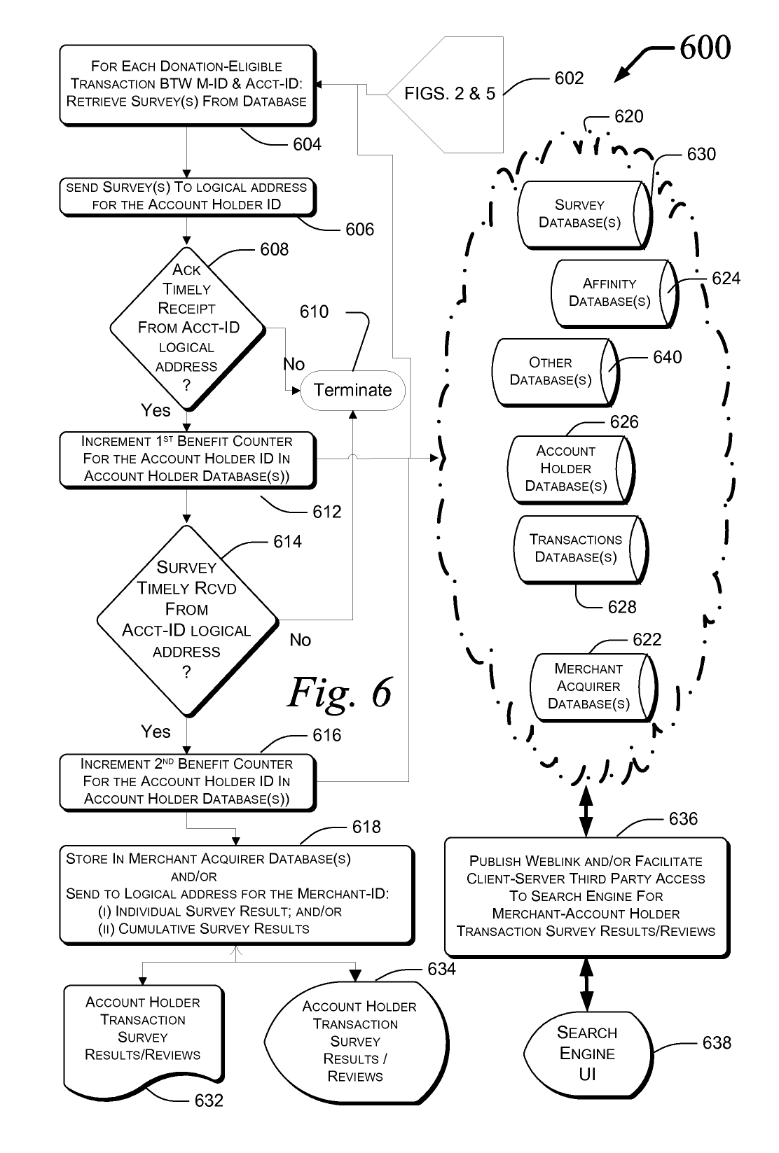

When the examination at step 518 determines that a donation is to be made by the Merchant (m) 410 to affinity (f) 484, the Account Holder (p) 408 can be sent a survey at step 522, where the data for such surveying may also be auto-boarded in Process 500 at step 510 or elsewhere. Step 522 is described below with respect to FIG. 6.

The flowchart in FIG. 6 illustrates an exemplary process 600 optionally extending, at step 602 thereof, processes 200 and 500 respectively illustrated in FIGS. 2 and 5. Process 600 is enabled, at least in part, via access to one or more entries in one or more databases in communication via one or more networks 620, Process 620 begins at step 602 and moves to step 604 where, for each donation-eligible transaction that takes place between Merchant (m) 910 and Account Holder (p) 908, a retrieval is made from one or more database(s) 620 of a survey of questions, which questions in the one or more databases 630 may have been auto-boarded, or manually changed, for the transacting merchant. The survey can be a series of questions that the merchant, or a third party, would like to have the account holder answer. By way of non-limiting example, the questions can ask the account holder, having had the benefit of the experience of having conducted a transaction with the merchant, to give one or more subjective opinions, one or more objective facts, and/or both, as pertains to the merchant's provision of goods and/or services during the course of the transaction with the merchant. The content of the survey can be derived from questions in the one or more databases 630, where those questions can be static, changing by time or number of transactions with the merchant, or randomly generated by use of an algorithm such as a predictive analytic algorithm.

The survey retrieved from the one or more databases 630 and then sent to a logical address for the account holder at step 606. At step 608, a determination is made as to whether or not the account holder received the survey. If such a receipt is acknowledged, then, optionally, a counter for the account holder is incremented 612. The account holder's incremented counter provides a benefit as an incentive to allowing acceptance of surveys at the logical address. Stated otherwise, the account holders are provided with an incentive if the account holder will allow the merchant to send surveys to the account holder. The incentive can be non-monetary, such an additional donation to be made to the one or more account holder selected entities of affinity, or monetary, such as an extra sweepstakes entry for the account holder. The account holder can be informed of this incentive, for example, within the same message that was sent to the account holder as pertains to the merchant's donation to the entity of affinity. If no acknowledge is received as to the account holder's receipt of the survey, then process 600 terminates at step 610.

At step 614, a determination is made as to whether or not the account holder sent a response to the survey. If so, then, optionally, another counter for the account holder is incremented 614. This second increment to the account holder's counter also provides a benefit as an incentive to send survey responses. Again, the incentive can be non-monetary, such an additional donation to be made to the one or more account holder selected entities of affinity, or monetary, such as an extra sweepstakes entry for the account holder. The account holder can be informed of this second incentive, for example, within the same message that was sent to the account holder as pertains to the merchant's donation to the entity of affinity. If no response is received to the survey, then process 600 terminates at step 610.

Each response to each survey that is received from each account holder can be stored, at step 618 in one or more entries in the one or more databases that are in communication via one or more networks 620. The corresponding merchant with whom the merchant conducted the transaction can be sent the survey response either in batch and/or in real-time as shown at reference numerals 632, 634. The survey results can be selectively obscured as to some or all of the content provided by, or otherwise linked to, the account holder so that the account holder's identify and/or demographics can be fully or partially anonymous when seen by the merchant or third parties.

At step 636, one or more web-links can be published to the merchant, the account holder, and third parties so as to facilitate client-server access, via a search engine having UI 638, to the results of the merchant-account holder transaction surveys. The search engine will provide results to clients who want to have consumers' assessments as to those goods and services provided by merchants' with whom those consumers' have conducted actual transactions, where the merchants gave contributions (e.g., to local charities) because the transaction had been conducted.

FIG. 7 illustrates, for a Merchant having a geographic address within one type of a low population density Merchant-Community, navigation algorithm results for each of a plurality of transportation modes for a geographic address associated with an account holder. By way of example, the specific type of low population density might derived from accessible private and/or government data as being a mixed suburban and light industrial demographic that is in turn used in order to auto-populate predetermined and corresponding Merchant-Community Navigation Time Maximums as shown at reference numeral 704.

Reference numeral 702 shows a geographic address attributed to a merchant and reference numeral 706 shows a geographic address attributed to an account holder. Reference numeral 704 shows a Merchant-Community Identifier that includes a maximum travel time with and without real time travel conditions weighting. In some implementations, the merchant has no obligation to make a donation to one or more customer selected affinity entities unless the customer's travel time, using at least one of the modes of transportation I though V as seen, respectively, at reference numerals 708-716, is not greater than the maximum(s) at seen at 704. As such, the merchant will incent only those customers who live close by in terms of travel time. Stated otherwise, the merchant's incentive is given only to a customer who is more likely to spend a significant portion of their spending at merchants who have a location that is close to where the customer resides in terms of travel time by any likely mode of transportation that the customer will use to travel to those merchants' locations.

Reference numeral 708 shows respective calculations for different routes 1 through M for a mass transit mode of transportation, where each calculation is for a travel time using mass transit as the mode of transportation from address 706 to address 702.

Reference numeral 710 shows respective calculations for different routes 1 through W for walking as a mode of transportations, where each calculation is for a travel time to walk from address 706 to address 702.

Reference numeral 712 shows respective calculations for different routes 1 through B for bicycling as a mode of transportation, where each calculation is for a travel time to ride a bicycle from address 706 to address 702.

Reference numeral 714 shows respective calculations for different routes 1 through D for using an automobile as a mode of transportations, where each calculation is for a travel time to drive from address 706 to address 702.

Reference numeral 716 shows respective calculations for different routes for other modes of transportations, where each calculation is for a travel time using such other modes to travel from address 706 to address 702 address. Where such other transportation mode data is available, the other modes of transportation can include, but need not be limited to roller blading, roller skating, Segway®, motor driven cycle, row boat, canoe or kayak, water taxi, swimming, jogging, and any combination of any transportation mode that might also be used as a method to calculate travel time from address 706 to address 702.

FIG. 8 illustrates, for a Merchant having a geographic address within one type of a high population density Merchant-Community, navigation algorithm results for each of a plurality of transportation modes for a geographic address associated with an account holder. By way of example, the specific type of high population density might derived from accessible private and/or government data as being a densely populated urban demographic where taxi cabs predominate use of private automobile use and there are a plethora of mass transit options readily available. These accessible private and/or government data can then be used in turn in order to auto-populate predetermined and corresponding Merchant-Community Navigation Time Maximum(s) that can be shown, for instance, at reference numeral 804. In some implementations, the merchant has no obligation to make a donation to one or more customer selected affinity entities unless the customer's travel time, using at least one of the modes of transportation I though V as seen, respectively, at reference numerals 808-816, is not greater than the maximum(s) at seen at 804. As such, the merchant will incent only those customers who live close by in terms of travel time. Stated otherwise, the merchant's incentive is given only to a customer who is more likely to spend a significant portion of their spending at merchants who have a location that is close to where the customer resides in terms of travel time by any likely mode of transportation that the customer will use to travel to those merchants' locations.

In some implementations, the respective geographic addresses of customer and merchant, whether self-selected or otherwise, when retrieved from one or more network accessible databases, can be compared, using processes, procedures, and methodologies enabled herein, to determine whether the merchant and its customer have the same local community. This comparison ensures that the merchant will incent only those customers who are associated with geographic addresses that are close to that of the merchant's. It is beneficial for the merchant to incent only those customers who are likely to navigate, within a predetermined time, from their pre-set geographic locations (whether these locations are self-selected occupational, recreational, or residential communities, or otherwise) to the merchant's geographic location because those customers are more likely to spend a significant portion of their spending at merchant locations to which those customers can navigate within the predetermined time. Conversely, it may not be beneficial for a merchant to give an incentive to a customer who is associated with a geographic address that is so far away from the merchant's geographic address that will be unlikely that such as customer will spend most of its spending at merchant locations that requires such significant travel times.

Reference numeral 802 shows a geographic address attributed to a merchant. Reference numeral 804 shows a Merchant-Community Identifier that includes a maximum travel time but does not show real time travel conditions weighting, given that automobile traffic driving conditions are an unlikely navigation time factor in the particular type of population density of the Merchant-Community. Reference numeral 806 shows a geographic address attributed to an account holder.

Reference numeral 808 shows respective calculations for different routes 1 through D for using an automobile as a mode of transportations, where each calculation is for a travel time to drive from address 806 to address 802.

Reference numeral 810 shows respective calculations for different routes 1 through M for a mass transit mode of transportation, where each calculation is for a travel time using mass transit as the mode of transportation from address 806 to address 802.

Reference numeral 812 shows respective calculations for different routes 1 through W for walking as a mode of transportations, where each calculation is for a travel time to walk from address 806 to address 802.

Reference numeral 814 shows respective calculations for different routes 1 through B for bicycling as a mode of transportation, where each calculation is for a travel time to ride a bicycle from address 806 to address 802.

Reference numeral 816 shows respective calculations for different routes for other modes of transportations, where each calculation is for a travel time using such other modes to travel from address 806 to address 802 address. Where such other transportation mode data is available, the other modes of transportation can include, but need not be limited to roller blading, roller skating, Segway®, motor driven cycle, row boat, canoe or kayak, water taxi, swimming, jogging, and any combination of any transportation mode that might also be used as a method to calculate travel time from address 806 to address 802.

Referring now to FIG. 9a, a screen shot 902 features input and displays fields by which a Merchant (m) 310, or agent thereof, can input terms and conditions under which the Merchant (m) 310 is willing to become legally bound to make a donation to an Affinity (k) 398. Note also that the displayed information can automatically populated by access to and retrieval of data from one or more of the databases illustrated in FIG. 9 as pertains to the designation of entities corresponding to those communities to which account holders, merchants, issuers, acquirers, and other parties have affinities, where each contribution is made by a merchant to an entity incident to a transaction between an account holder and the merchant. FIG. 9a shows fields for a field for Merchant Identifier which, by way of non-limiting examples, can be a government tax identifier, or other globally unique identifier, and a field for a Merchant-Community or Merchant Community Identifier (MCI). The MCI, by way of non-limiting example, can be a code to which is assigned a predetermined maximum travel time for a customer to travel from their residence to the merchant's address using any mode of transportation, as further explained above with respect to FIGS. 7-8.

Each row in screen shot 902 represent all or a portion of twenty-four (24) hour day of the calendar year. Columns in each row of the table seen in screen shot 902 are, from left to right, as follows: 1st the numerical calendar day of the year; 2nd the hyphenated starting and ending of a time period within the calendar day; 4th a percentage of a currency amount of any one (l) transaction that the Merchant (m) 310 will commit to make to an Affinity (k) 398; 5th the minimum currency amount of the transaction before the commitment by the Merchant (m) 310 to make the donation will arise; 6th maximum amount of donation that the Merchant (m) 310 is willing to make for any one (l) transaction; 7th an identifier for the Affinity (k) 398 to whom the Merchant (m) 310 is to make the donation as described in the row.

By way of example, and not by way of limitation, the data input by the Merchant (m) 310, or agent thereof, for display on screen shot 902 can be stored in Donations Biz Rules (b) 380 or other location logically accessible, via one or more networks or otherwise, to Donation Audit Web Service 314. These data can also be automatically pre-loaded for Merchant (m) 310 via an automatic initiating service that allows the Merchant (m) 310 to be entered as a participant in a local community donations program through traffic each store location of the Merchant (m) 310 in the local community will be incentivized to increase.

Optionally, screen shot 902 can also be used by other donors seen in FIG. 3, to input and see a display of those fields by which the donor, or agent thereof, can input terms and conditions under which the donor is willing to become legally bound to make a donation to an Affinity (k) 398. Such other donors include each issuer (j) 304, the transaction handler 302, and the acquirer (i) 306.

Referring now to FIG. 9b, a screen shot 904 features input and displays fields by which an Account Holder (p) 308, or agent thereof, can direct a third party donor, such as a Merchant (m) 310 with whom the Account Holder (p) 308 is conducting a transaction, to become legally bound to make a donation to an entity of affinity as designed by Affinity (k) 398. Each row in screen shot 904 represents a different entity of affinity. Note also that the displayed information seen in FIG. 9b can automatically populated by access to and retrieval of data from one or more of the databases illustrated in FIG. 3 as pertains to the designation of entities corresponding to those communities to which account holders, merchants, issuers, acquirers, and other parties have affinities.

Other donors so directed by the Account Holder (p) 308's data entry can include each issuer (j) 304, the transaction handler 302, and the acquirer (i) 306. The Affinity (k) 398 is expressed in each row by an integer indexed in both T and T variables. By way of example, such an indexing system might identify a specific Affinity (k) 398 by the code 105(064) (q2e), where ‘105’ represents the international organization “United Way”, the index ‘064’ represents that organization's affiliated entity within the United States of America, and the index ‘q2e’ represents the borough of Greenwich Village at the southern portion of the geographical island of Manhattan in the city of New York of the State of New York.

For screen shots 902-904, input and selection of data for each entity of affinity can be via a typical user experience including but not limited to keyboard data entry, pull down menus, pictograph optical scanning with a cellular telephony device as read from print or electronic media rendering, etc. Horizontal 918 and vertical 920 panning can be user activated to move that portion of the display being rendered horizontally and vertically, respectively.

Other columns in each row of the table seen in screen shot 904 are, from left to right, as follows: 1st the percentage of the donor's donation that the account holder directs to be donated to the entity of affinity identified in the 2nd column; 3rd: a yes or no indication whether the account holder will match the donor's donation to that entity of affinity; and the 4th through the 7th columns: the maximum currency amounts that the Account Holder will commit to give to the identified entity of affinity for the current year, quarter, month and day, respectively. The bottom of screen shot 904 shown the maximum total of all matching contributions to all entities of affinity that the Account Holder (p) 308 is willing to commit for the current year, quarter, month and day, respectively.

To pay the donation to the entities of affinity so specified in screen shot 904, the Account Holder (p) 308's issuer (j) 304 can pay the entity of affinity (k) 398 and place a debit in that currency amount on the Account Holder (p) 308's periodic revolving credit statement. The Account Holder (p) 308, upon receipt of the statement, can thereafter make a total payment to the issuer (j) 304 of the currency amount of the donation that appears as a debit on the statement along with the other credit charges that also appear on the Account Holder (p) 308's statement.

Both the Account Holder (p) 308 and the Merchant (m) 310, or their agents, can change or disable a donation commitment at any time by accessing a server that serves web pages rendering screen shots 902, 904, respectively. Thus, donation commitments can be enabled or disabled using a real time user interface. By way of example, and not by way of limitation, such servers can be hosted by the Donation Audit Web Service 314 seen in FIG. 3.

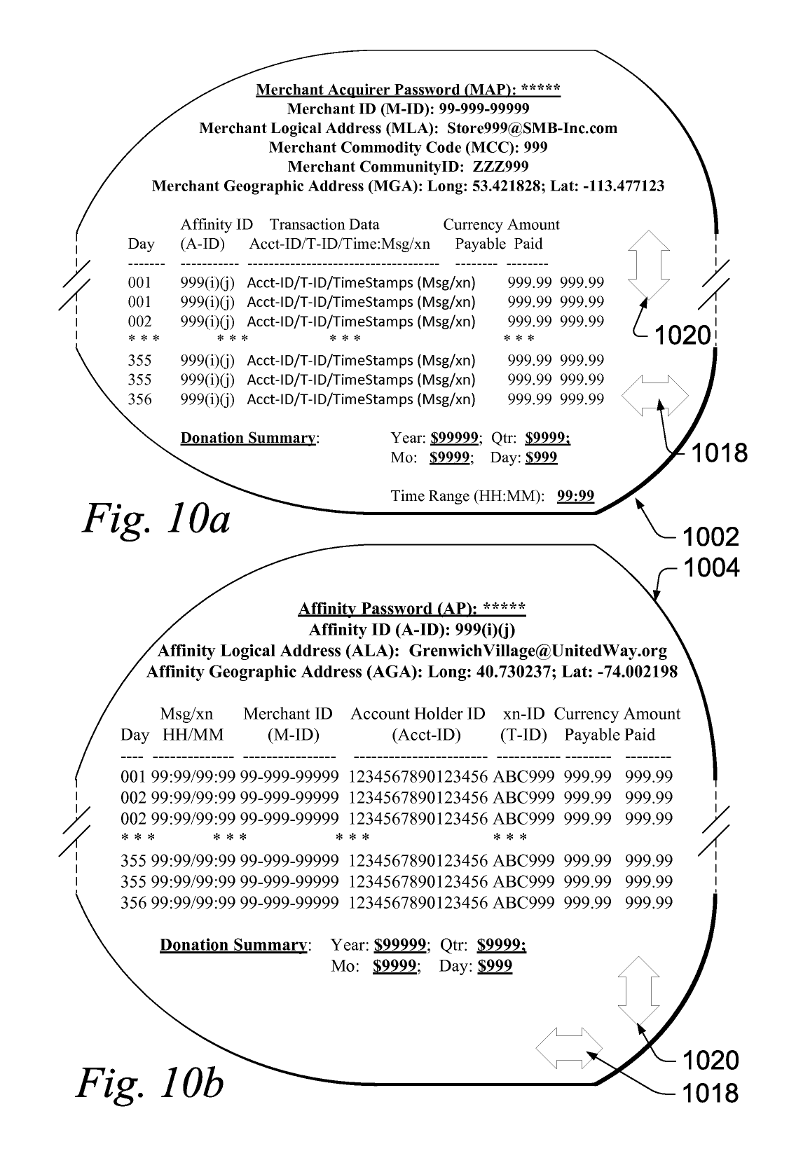

FIG. 10a is screen shot characterizing an exemplary user interface 1002 for the display and updating of Merchant (m) Acquirer Database Entries 990 as seen in FIG. 9. For each merchant, there is a corresponding Merchant Acquirer Password (MAP) to provide access to the Merchant Acquirer Database (990), a Merchant ID (M-ID) which can be, by way of non-limiting example, a tax identification number, a Merchant Logical Address (MLA) which can be an e-mail or World Wide Web logical address, a Merchant Commodity Code (MCC), a Merchant Community-Identifier (MDI) as explained above with respect to FIGS. 7-8 and 9a, and a Merchant Geographic Address (MGA) which can be, by way of non-limiting example, longitude and latitude coordinates. A series of data for respective transactions are recorded for display, and possible update, for each merchant by a properly credentialed data entry authority. These transaction data include: (i) the date that the transaction was conducted by the merchant with an account holder (e.g., from calendar day 001 at the beginning of a calendar year to calendar day 365 at the end of the calendar year); (ii) an identifier for the affinity to whom a contribution is to be made as represented by its Affinity ID (A-ID); (iii) a string of characters describing: (a) an identifier for the account upon which the transaction was conducted (Acct-ID); (b) an identifier for the transaction (T-ID); (c) the time on the date that the Account Holder (p) 408 (Acct-ID) was sent an Affinity Donation Message (Msg) from Merchant (m) 410 (M-ID); (d) the time on the date that Account Holder (p) 408 (Acct-ID) conducted the transaction (xn) with the Merchant (m) 410 (M-ID); and (iv) a Currency Amount for a contribution to be paid, and that has been paid, by the Merchant (m) 410 designated by M-ID. Also seen in FIG. 10a are summary statistics for contributions of the merchant by the year, the quarter year, the month, and the day, where the statistics can be for those contributions to be made and/or that have been made, as well as a Time Range, expressed in hours and minutes (HH:MM). The Time Range is used in business rules to determine whether the account holder acted promptly in conducting a transaction with the merchant after receiving a message from the merchant. Stated otherwise, the time between the message and the transaction exceeds the Time Range, the merchant is not obligated to make the donation.

FIG. 10b is screen shot characterizing an exemplary user interface 1004 for the display and updating of Affinity (f) Database Entries 994 as seen in FIG. 9. For each Affinity, there is a corresponding Affinity Password (AAP) to provide access to the Affinity Database (994), an Affinity ID (A-ID), an Affinity Logical Address (ALA) which can be an e-mail address, and an Affinity Geographic Address (MGA) which can be longitude and latitude coordinates. A series of data for respective transactions are recorded for display, and possible update, for each merchant. These transaction data include: (i) the date that the transaction was conducted by the merchant with an account holder (e.g., from calendar are 001 to calendar day 365); the time on the date that the Account Holder (p) 908 was sent an Affinity Donation Message (Msg) from Merchant (m) 910 (M-ID); the time on the date that Account Holder (p) 408 (Acct-ID) conducted the transaction (xn) with the Merchant (m) 410 (M-ID); an identifier for the Account Holder (p) 408 (Acct-ID) who conducted the transaction; an identifier for the transaction which may be obtained from the Authorization Response (i.e., Transaction ID or T-ID), and a Currency Amount for a contribution is to be paid, and that has been paid, by Merchant (m) 410 to the affinity designated by A-ID. Also seen in FIG. 10b are summary statistics for contributions to the affinity by the year, the quarter year, the month, and the day, where the statistics can be for those contributions to be made or that have been made.

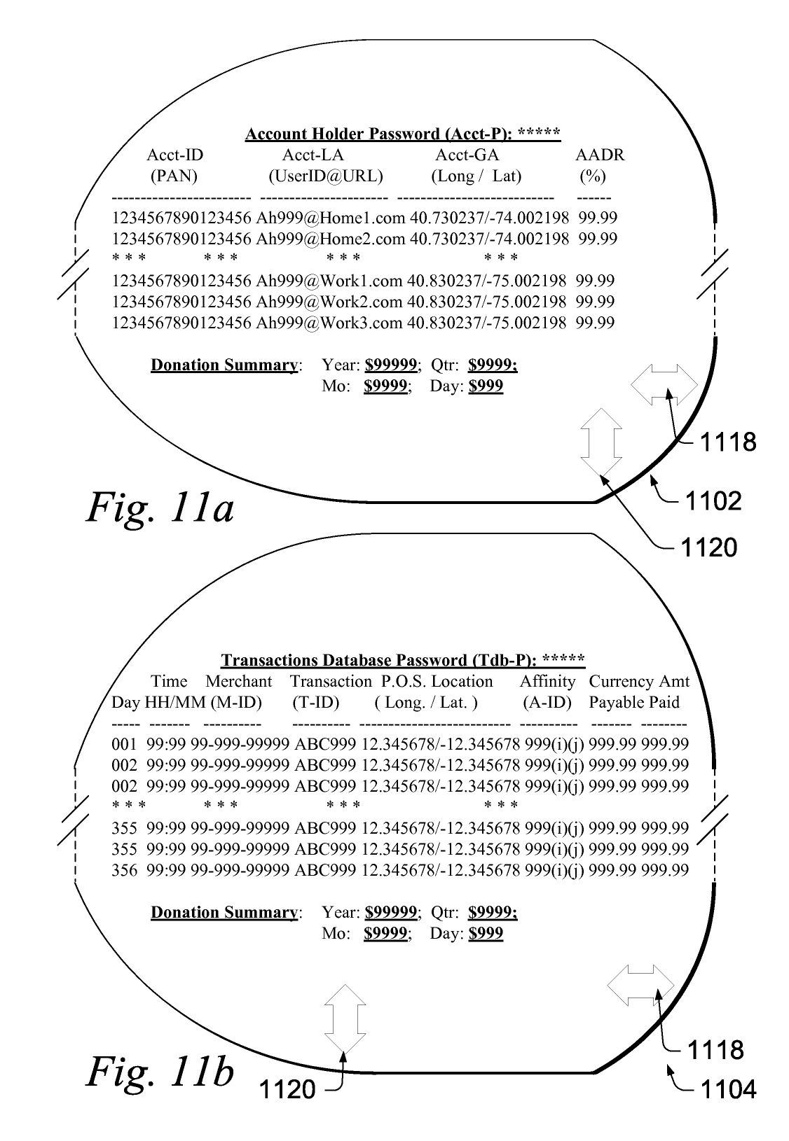

FIG. 11a is screen shot characterizing an exemplary user interface 1102 for the display and updating of Account Holder (p) Database entries 492 as seen in FIG. 4. As seen in FIG. 11a, each account holder has an account holder password (Acct-P) that can be used to access Account Holder Database (492) to obtain therefrom about information pertaining to the account holder. Each account holder can have more than one account that has been issued to them by an issuer as shown in FIG. 11a by a series of Personal Account Numbers (PAN) or other Globally Unique Identifier (GUID). Each PAN and/or GUID can have a logical address such as an e-mail address, and a geographic location for a billing statement—which can be characterized by longitude and latitude coordinates. If the account holder wishes to make a contribution to an entity to which the merchant is also contributing incident to a transaction, a percent of the currency amount for each transaction on each PAN and/or GUID can be displayed and/or updated as shown in FIG. 11a. Alternative implementations of account holder contribution methodology are also discussed herein with respect to FIG. 9b. Also seen in FIG. 11a are summary statistics for contributions made by the Account Holder to all affinities by the year, the quarter year, the month, and the day, where the statistics can be for those contributions to be made and/or that have been made.

FIG. 11b is screen shot characterizing an exemplary user interface 1104 for the display and updating of information in the Transactions Database entries (xn) 496 as seen in FIG. 4. Transactions Database entries (xn) 496 are accessible by use of a password (Tdb-P) to display and/or edit information shown in FIG. 11b. For each transaction that is shown in FIG. 11b: (i) the date that the transaction was conducted by the merchant with an account holder (e.g., from calendar are 001 to calendar day 365); (ii) the time on the date that Account Holder (p) 408 conducted the transaction with the Merchant (m) 410 (M-ID); (iii) the Transaction IDentifier (T-ID) from the corresponding Authorization Response; (iv) a geographic location that corresponds to a community into which the merchant will make a contribution as can be specified, by way of non-limited example, as longitude and latitude coordinates (v) the affinity to whom the merchant's contribution is to be made as represented by its Affinity ID; (vi) and a Currency Amount for a contribution to be paid, and that has been paid, by the merchant designated by M-ID. Also seen in FIG. 11b are summary statistics for contributions of all merchants by the year, the quarter year, the month, and the day, where the statistics can be for those contributions to be made or that have been made.

Referring now to FIG. 12a, with further reference to FIGS. 8-9, screen shot 1204a allows a merchant, or its agent, to input one more minimum and maximum navigation times for different times on different days of the year. Each input navigation time range is used to determine whether or not the merchant will be obligated to make a donation to an affinity entity or charity. In practice, information derived from an affirmative authorization response for a transaction between the merchant and an account holder is obtained. This information will contain sufficient data that can be further used to retrieve and/or determine physical address information for the merchant and the account holder. Once physical address information for the merchant and the account holder customer are known, these physical addresses are used with a navigation time algorithm to determine the navigation time from the physical address of the account holder to the physical address of the merchant. If the determined navigation time does not exceed the maximum navigation time (which may be weighted by real-time traffic conditions) for one or more transportation nodes seen in the middle of screen shot 1204a in FIG. 12a, and the date and the time of the transaction are within a time period and day which may have been previously specified by the merchant's input for the particular day and time as shown at the top of screen shot 1204a, then the merchant will be obligated to make a donation to an affinity entity or charity. Otherwise, the merchant is not obligated to make a donation to an affinity entity or charity.

The one or more different transportation modes seen in screen shot 1204a in FIG. 12a each show a maximum navigation times for different transportation modes. One such transportation mode can be by automobile, another by walking, and other by mass transit, another by a specific combination of different transportation modes (e.g., walk, subway, bus, and walk), etc.

Any of various navigation algorithms, both known and yet to be developed, can be used to determine whether the time, using one or more travel methods, is within the merchant's input navigation time range. The result of the algorithm's determination will ascertain whether or not the merchant and its customer share the same local community or ‘neighborhood’, and the merchant will accordingly be obligated to make donation when the customer buys something from the merchant. By way of example, the merchant and its customer might be determined to be within the same local community if the automobile drive time, as determined from one or more databases of contemporary cartographic road system information, to navigate between the merchant's brick and mortar store and the customer's residence is less than a predetermined time threshold (e.g., 17 minutes). The navigation algorithm used with the input from screen shot 404 and the respective physical addresses of merchant and account holder can be varied.

As stated above, studies show that the majority share of a community resident's annual spend, at least for some communities, tends to stay in their local community, a merchant in that community would like to incentivize residents in that community to conduct transactions with the merchant. As such, the merchant residing in a heavy-local spending community can choose to make an offer to any such community resident that a donation will be made to one or more affinity entities or charities that are designated by the community resident. The merchant's donation, however, can be made conditional. One such condition can be that the community resident resides in the community where the transaction is conducted with the merchant—where the community residence criteria are made upon a derivation of a specific navigation algorithm. A commercial reason behind the merchant's donation incentive is to attract customers who are likely to be repeat customers who will frequently shop at the merchant's store. Although somewhat dependent upon the type of goods and services provided by the merchant, and the location where the merchant is physically located, the type of customer that is most likely to be a repeat, frequent customer might be determined to be one who lives or works relatively close to the merchant's store. As such, screen shots seen in FIGS. 12a-12b provide input fields to receive incentives directed towards likely frequent shoppers, while disallowing donation incentive to customer who will be unlikely to travel to the merchant's store frequently due to distance, difficulty of the commute, etc.

In some implementations, the obligation for the merchant to donate can be tested in a variety of ways. One test for the customer's residence can be made by calculating the duration of a trip to navigate from a geographic location associated with community resident to a geographic location associated with the merchant. This calculation can be made by using one or more navigation time estimation algorithms. Stated otherwise, the duration of a trip to navigate from a geographic location associated with an account holder to a geographic location associated with the merchant can be calculated by using one of more navigation time estimation algorithms. By way of example, and not by way of limitation, any of the following algorithms, either alone or in combination, can be used when calculating a navigation time between places respectively associated with customer and merchant: (i) Depth-First-Search (DFS); (ii) backtracking search; (iii) Dijkstra's algorithm; (iv) Krushkal's algorithm; (v) Prim's algorithm, (a.k.a. DJP algorithm; (vi) the Jarnik algorithm or the Prim-Jarnik algorithm; (vii) Reverse-Delete algorithm; (viii) Bor [symbol] vka's algorithm; (ix) a navigation algorithm now conceived; (x) a navigation algorithm both conceived and reduced to practice; and/or (xi) a navigation algorithm that is developed in the future.

Another way to calculate navigation time between places respectively associated with customer and merchant is to outsource calculations to a public or private web service by transmitting the respective geographic place identifiers to an online navigation service for calculation of navigation time and receive by the navigation time estimate. By way of example, the pair of places can be sent to an online service for subsequent return of a navigation time estimate as are provided by a Google® maps service, a Bing® maps service, a Garmin® maps service, a Delorme maps service, a TomTom® maps service, a Mapquest® maps service. The navigation time estimate calculated, or received back from a web mapping service, can be a time for one or more transportation modes, including walking, automobile or taxi, bicycling, mass transit, or a combination thereof.

As shown in FIGS. 12a-12b, a merchant can designate, if each of several different time periods during each calendar day, the navigation time under which the merchant will make a donation to one or more charities designated by a customer who transacts with the merchant, as well as the corresponding percentage of the transaction amount that the merchant will donate. As such, a merchant can input data such that a greater or lesser donation is made as depends up the time, the day, and the navigation time, by any of several different modes of transportation, between locations respectively associated with the merchant and the customer who transacts with the merchant.

In the case of a geographic area having a high-density population (e.g., a city), a merchant may input small navigation times because local shoppers live close to the merchant's location. As such, the merchant is thereby committing to donate only those charities designed by customers who live close to the merchant—such as in ‘walking distance’. Alternatively, in rural and sparsely populated areas, the merchant may input larger navigation times because local shoppers are likely to drive in an automobile as the most reasonable transportation mode to arrive at the merchant's store. As such, the merchant is thereby committing to donate only those charities designed by customers who live close enough to drive a reasonable distance to the merchant's store.

A merchant may choose not to make a donation to any customer who is identified with a residence or location that is too far from the merchant's location to represent potential frequent repeat business. As such, input by the merchant would be unfavorable towards any donation to the designated charities of a shopper who is unlikely to regularly shop at the merchant's business.

The navigation time input by the merchant might preferably be dependent upon the types of goods and services provided by the merchant. Merchant offering only commodity items, such as grocery stores, would be like to input shorter navigation times that merchants typically providing rare and hard-to-find items for which customers are more likely to be willing to make longer commutes in order to make purchases.

FIG. 12b allows a merchant to input different navigation time thresholds for any of several different kinds of transportation modes, such as walking, driving, mass transit, and there combinations. For instance, if at least one of the navigation times from a customer's residence to the merchant's store for different transportation modes is less that an input threshold, then the merchant will make a donation the customer's identified charities after the customer's transaction with the merchant has been authorized.

FIG. 12b shows a portion of screen shot 1204 where the merchant can input an identifier for one or more customers (e.g., an account or member number), where the merchant will donate to each such customer's identified charities. Note that, in this implementation and variations thereof, the merchant's obligation to donate is fixed regardless of any navigation time that may apply for the customer to travel from the customer's resident to the merchant's store, although other criteria may apply, such as the date and time parameter seen in FIG. 12a which must be satisfied by the date and time of the transaction. Alternatively, input can be made by the merchant per screen shot 1204b in FIG. 12b such the merchant will donate to each identified customer's charities regardless of navigation time or time of day, though within the limits of donation see a the bottom of screen shot 1202.

The local community of each of the merchant and its customer can be determined in still other ways in other implementations, where the merchant's obligation to donate will not be fixed unless the respective physical addresses of merchant and customer are in the same community or neighborhood according to a predetermined algorithm. Any such local community determination can be made in any of several different methods, or combinations thereof, according to the merchant's preference as to what algorithm is mostly likely to attract the most favorable foot traffic to the merchant's brick and mortar store. One such method is a political or legal division, that is, the merchant's place of business is determined to be in the same political or legal division as that of its customer's residence, such as the same province, state, county, prefecture, city, city-state, borough, etc. Another such comparison can be whether the merchant's place of business has a governmentally issued postal code that is the same or within a predetermined proximity as that of its customer's residence. Yet another such comparison can be whether the merchant's place of business and its customer's residence are physically proximate within a predetermined factor by any of a variety of measures or combinations thereof. For example, latitude and longitude coordinates might be known for both the merchant's place of business and the residence of its customer. These coordinates can be used to determine whether the linear distance there between is within a predetermined distance to ascertain whether or not the merchant and its customer share the same local community.

A further alternative implementation will use an algorithm that uses the population density of the merchant's brick and mortar store and the customer's residence, as well as real time transportation data such as traffic conditions, bus and subway availabilities, etc. If the population density exceeds a predetermined density, then the merchant and its customer might be determined to be within the same local community if the time to walk, bicycle or take public transportation between the merchant's brick and mortar store and the customer's residence, as determined from one or more databases of contemporary topographic, mass transit, and/or pedestrian cartographic system information, is less than a predetermined time threshold (e.g., 55 minutes).

Still another such comparison can be whether the merchant's place of business and its customer's residence are proximate or the same according to voting, electoral, or political districts. The district use can be determined by an official method, an unofficial method, or a combination of methods. By way of example, measurements known within the political gerrymander sciences can be used, including but not limited to a minimum district to convex polygon ratio, shortest split line algorithm, minimum isoperimetric quotient, etc.

The local community corresponding to that of the merchant and its customer, and separations there between (if any), can be determined from any combination of linear distance, mode-specific navigational transportation travel time, political separation, postal designation, and/or hybrid algorithm that takes into consideration geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owned and leased properties, etc. Given the foregoing, an algorithm might find that the merchant and its customer are members of the same community, not members of the same community, or are both members of more than one of the same communities as determined by the algorithm.

Similar or different algorithms that are used to determine the respective local community of the merchant and its customer can also be used to determine the local community of an affinity entity such as that shown on FIG. 1 at reference numeral 122, or as that shown as an Affinity Entity (k) 398 in FIG. 3, as discussed herein below. These determinations can be performed when a donation term is conditioned upon the location, neighborhood or community of the Affinity Entity (k) 398.

Data input in the user interface depicted by screen shots 1202-1204 can be stored in one or more of the Merchant DBs 380 or other location logically accessible, via one or more networks or otherwise, to Donation Audit Web Service 314. These data can also be automatically pre-loaded for Merchant (m) 310 via an automatic initiating service (e.g., an data auto-boarding or auto-populating operation) that allows the Merchant (m) 310 to be automatically entered as a participant in a local community charitable donation program that incentivizes increased local resident foot traffic to each store location of the Merchant (m) 310 in the local community. Note that auto-boarding allows small and medium sized merchants to enter such a program with little or no effort by using default data in auto-populating information to be used for the merchant's participation in the program, along with survey questions. After a Merchant (m) 310 has auto-boarded its data by way of a performance by an entity such as the merchant's acquirer (i) 306, its agent, or Donation Audit Web Service 314, Merchant (m) 310 can receive, by batch or near real-time, a survey result (see reference numerals 632-634 in FIG. 6) derived from input received from an Account Holder (p) 308 who conducted a transaction with the Merchant (m) 310,

As seen in FIGS. 9 a and 12a, each offer input by the merchant to donate to a local affinity entity is not be specific to a particular good or service that the merchant will provide to its customer in a transaction. Rather, the offer is specific to the entire transaction between the merchant and its customer. By way of example as to this type of offer specificity, the offer may obligate the merchant to make a donation of a certain percentage of the entire currency amount of transaction, or the offer may obligate the merchant to make a donation only if the transaction is conducted at a certain time of day or on a particular day of the week, or a combination of the foregoing. Although some terms of the offer may differ from some terms of the transaction, nevertheless, the merchant's offer to make a donation to a local affinity entity (e.g., a local charity) has the goal of fundamentally providing an incentive that causes, at least in part, the local community resident to navigate to the local merchant's brick and mortar store as new foot traffic, and ultimately to conduct a transaction that brings revenue to the brick and mortar store of the local merchant.

By way of exemplary implementation of data input to a field in screen shot 1204b in FIG. 12b, a received identifier might identify a specific Affinity Entity (k) 484 that is located in, and provide goods and services to, the borough of Greenwich Village at the southern portion of the geographical island of Manhattan in the city of New York of the State of New York, in the USA. By way of example, and not by way of limitation, a Community ID represented by the character string “ZZZ999)” could have an interpretation representing progressively smaller communities, for instance, the United States of America, the state of New York, the City of New York, the combined boroughs of Manhattan, and the borough of Greenwich Village at the southern portion of the geographical island of Manhattan in the city of New York of the State of New York. The name of the specific Affinity Entity (k) 398 represented by Affinity Entity Code having the character string “999(i)(j)” and the affinity name shown in screen shot 1204b as “dddddddddddddddddddd” can be the “Washington Square Food Bank”, which may be located in, and provide goods and services to, the borough of Greenwich Village at the southern portion of the geographical island of Manhattan in the city of New York of the State of New York, in the USA.

Note that the merchant can use screen shot 902 to specify multiple community IDs each representing a geographic location where the Account Holder (p) 308 either has a residence or operates a business in the geographic location. Also note that, for each such community ID specified by the merchant, the second column of the rows of screen shot 904 in FIG. 9b will preferably add up to 100%, thereby provide a percentage the donation made by the Merchant (m) 310 with whom the Account Holder (p) 308 conducting a transaction.

For screen shots 902-904 and 1204a-1204b, input and selection of data for each Affinity Entity can be via a typical user experience including but not limited to keyboard data entry, pull down menus, pictograph optical scanning with a cellular telephony device as read from print or electronic media rendering, etc. Horizontal 918, 1218 and vertical 920, 1220 panning can be user activated to move that portion of the display being rendered horizontally and vertically, respectively.

Screen shot 1204b in FIG. 12b shows a plurality of rows. Each row includes an affinity entity, the percentage of any donation that the account holder requires to be made to that affinity entity, an identifier for a community associated with the affinity entity, and a description or name of the affinity entity. Note that the sum of the second column of the row must equal one hundred percent (100%).

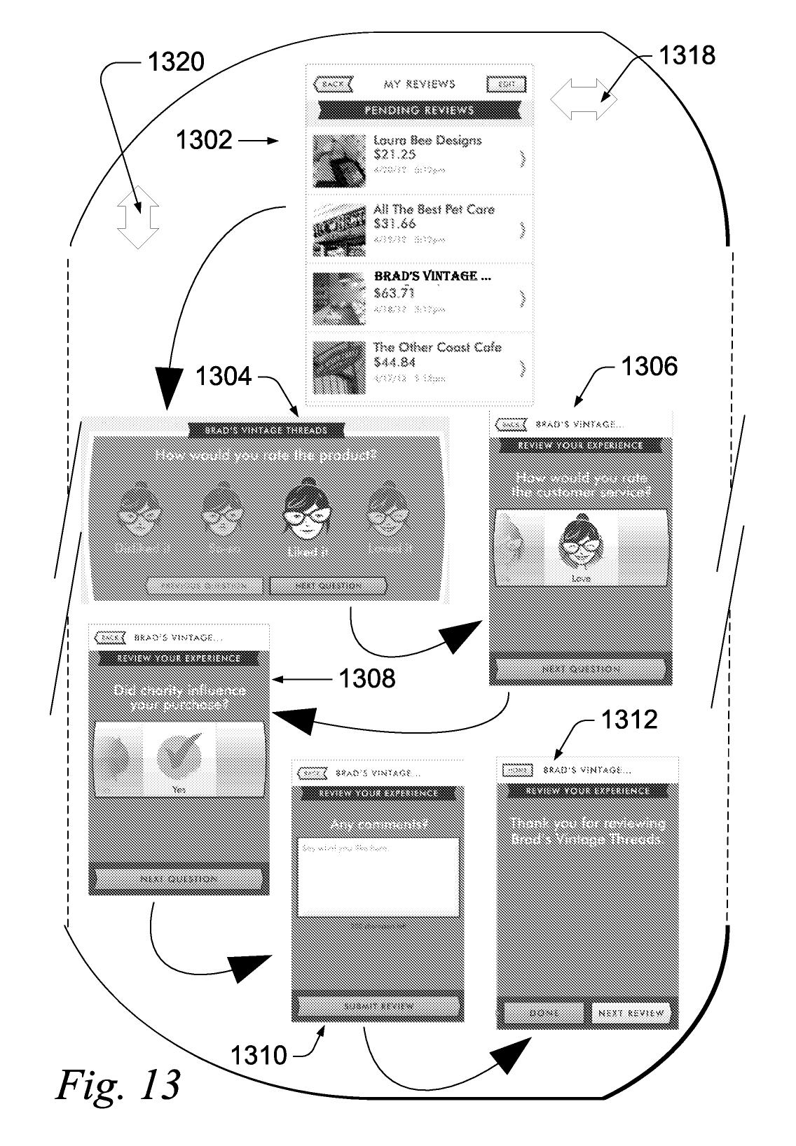

Referring now to FIG. 13, with further reference to FIGS. 2-3 and 5-6, a display screen is seen in FIG. 13 for displaying a user interface. The user interface displays a received and rendered survey corresponding to an authorized transaction conducted by an Account Holder (p) 308 with a Merchant (m) 310, where data input by the Account Holder(p) 308 is submitted for delivery to Merchant (m) 310. FIGS. 2 and 6, respectively at steps 211 and 522, show control being passed to a post-transaction survey process an example of which is illustrated by process 600 in FIG. 6.

Upon receipt by a user interface controlled by Account Holder (p) 308, or agent thereof, a selection of transactions for which surveys are requested is rendered at reference numeral 1302. A selection is conventionally made on the user interface, causing a rendering of the selected survey shown at reference numeral 1304. A selection of a survey answer is made by conventional input to the user interface, causing a rendering of the next survey question at reference numeral 1306. A selection of a survey answer to the survey question is made by conventional input to the user interface, causing a rendering of the next survey question at reference numeral 1308. A selection of a survey answer is made by conventional input to the user interface, causing a rendering of the next survey question at reference numeral 1310. An optional manual selection of textual response to the prior survey question is made by conventional input to the user interface, causing a rendering of the final survey screen at reference numeral 1312. The survey process for Account Holder (p) 308, or agent thereof, terminates and control is returned, by way of non-limiting example, for production of reports seen at reference numerals 632-634 in FIG. 6.

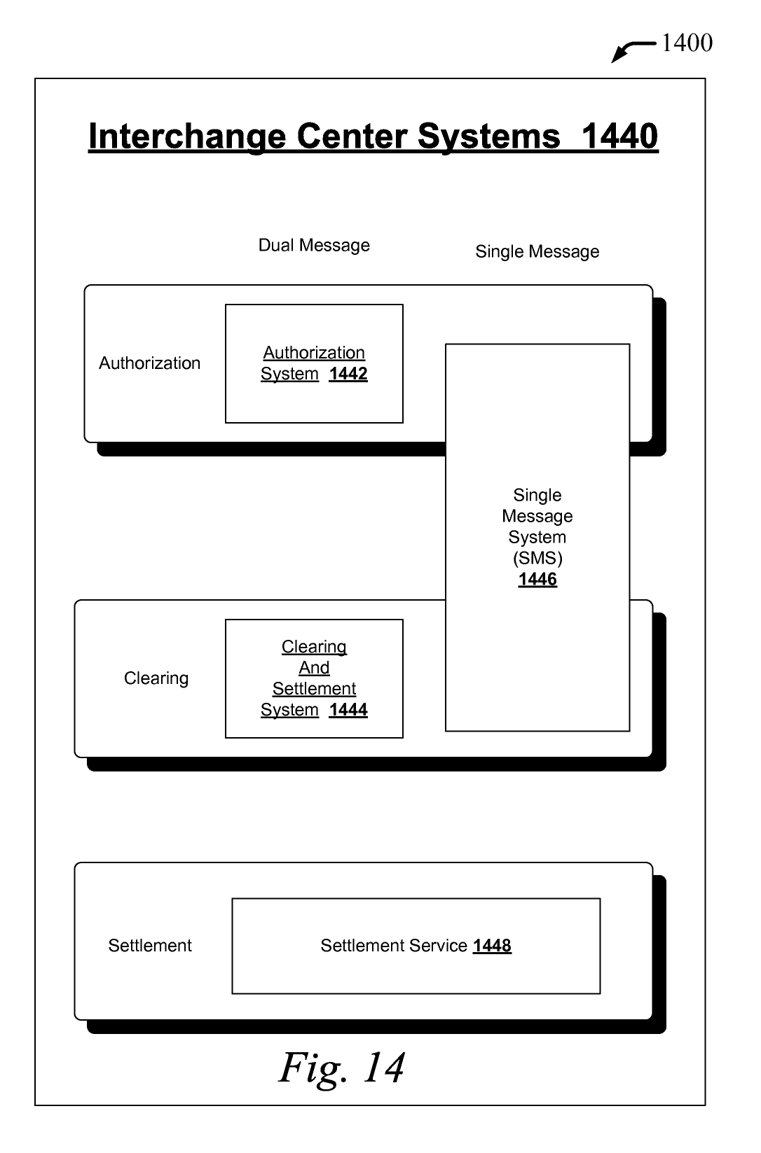

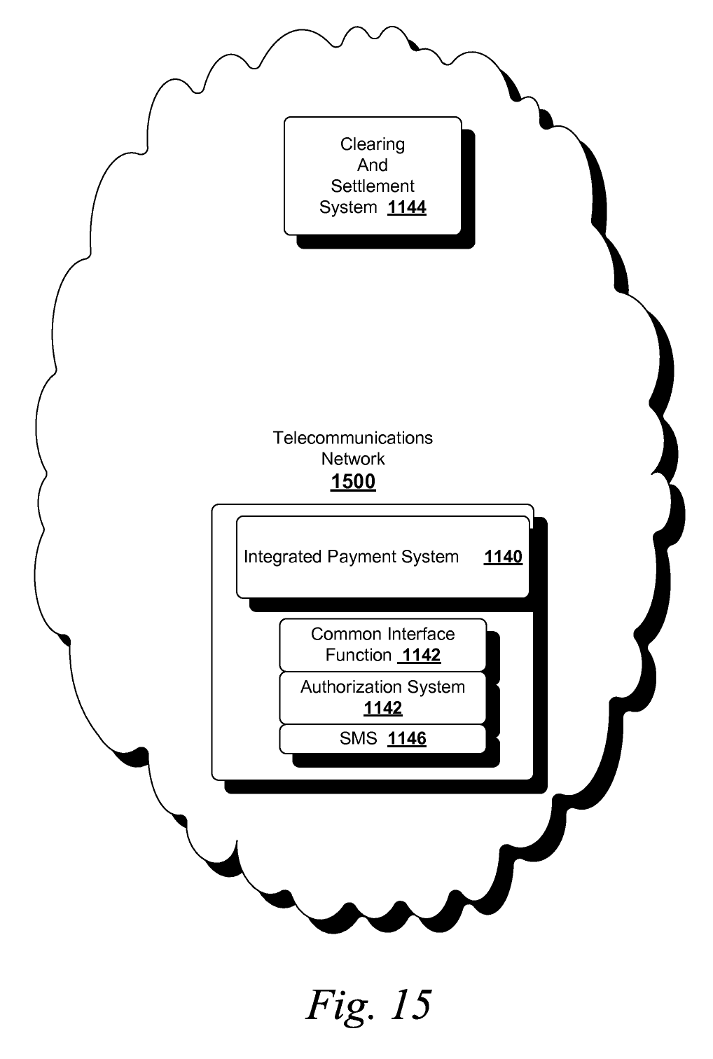

Referring now to FIGS. 14-15, with further reference to FIGS. 1 and 3-4, FIG. 14 illustrates Interchange Center systems 1440 housed within an interchange center to provide on-line and off-line transaction processing. Transaction processing, as shown in FIG. 3, uses access points 330, 332 between Transaction Handler 302 and each Acquirer (i) 306 and Issuer (j) 304. Other entities such as drawee banks and third party authorizing agents may also connect to the financial; network through an access point (not shown). An interchange center has systems, such as those seen at reference numeral 1440 see in FIG. 14, so as to be a data processing center that may be located anywhere in the world. Each interchange center houses the computer system that performs the network transaction processing. The interchange center serves as the control point for the telecommunication facilities of the network, which comprises high-speed leased lines or satellite connections, for instance as may be based on IBM SNA protocol. Preferably, the communication lines that connect an interchange center (Transaction Handler 302) to remote entities use dedicated high-bandwidth telephone circuits or satellite connections, for instance as may be based on the IBM SNA-LU0 communication protocol. Messages are sent over these lines using any suitable implementation of the ISO 8583 standard.

Access points 330, 332 are typically made up of small computer systems located at a processing center that interfaces between the center's host computer and the interchange center system 1440. The access point facilitates the transmission of messages and files between the host and the interchange center supporting the authorization, clearing and settlement of transaction. Telecommunication links between the Acquirer (i) 398 and its access point 332, and between the access point 330 and Issuer (j) 304 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. In addition, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

For dual message transaction, authorization system 1442 provides authorization. Authorization system 1442 supports on-line and off-line functions, and its file includes internal systems tables, a customer database and a merchant central file. The on-line functions of system 1442 support dual message authorization processing. This processing involves routing, account holder and card verification and stand-in processing, and other functions such as file maintenance. Reporting includes authorization reports, exception file and advice file reports, POS reports and billing reports. A bridge from system 1442 to a Single Message System (SMS) 1446 makes it possible for issuers and acquirers to use system 1442 to communicate with other issuers and acquirers using system 1446 and access the SMS gateways to outside networks.

Clearing and settlement system 1444 clears and settles previously authorized dual message transactions. System 1444 collects financial and non-financial information and distributes reports between members. It also calculates fees, charges and settlement totals and produces reports to help with reconciliation. A bridge forms an interchange between system 1444 processing centers and system 1448 processing centers.

Single message system 1446 processes full financial transactions and can also process dual message authorization and clearing transactions, as well as communicate with system 1442 using a bridge and accesses outside networks as required. System 1446 processes cashless issued account-based acquired transactions, for instance Visa, Plus, Interlink. Maestro, Cirrus, and others. By way of example, SMS files comprise internal system tables that control system access and processing, and an account holder database, which contains files of account holder data used for Personal IDentifier (PIN) verification and stand-in processing authorization. System 1446 has on-line functions that perform real-time account holder transaction processing and exception processing for authorization as well as full financial transactions. System 1446 also accumulates reconciliation and settlement totals. System 1446 also has off-line functions that process settlement and funds transfer requests and provide settlement and activities reporting. Settlement service 1448 consolidates the settlement functions of system 1444 and 1446 for cashless issued account-based acquired transactions into a single service for all products and services. Clearing continues to be performed separately by system 1444 and system 1446.

FIG. 15 illustrates another view of components of FIG. 14 in a telecommunications network 1500. Integrated payment system 1560 is the primary system for processing all on-line authorization and financial request transactions. System 1560 reports both dual message and single message processing. In both cases, settlement occurs separately. The three main software components are the common interface function 1562, authorization system 1542 and single message system 1546.

Common interface function 1562 determines the processing required for each message received at an interchange center. It chooses the appropriate routing, based on the source of the message (system 1542, 1544 or 1546), the type of processing request and the processing network. This component performs initial message editing, and, when necessary, parses the message and ensures that the content complies with basic message construction rules. Common interface function 1562 routes messages to their system 1542 or system 1546 destinations.

Referring again now to FIGS. 1, 3-4, and 14-15, further illustrations are seen of a telecommunications network that may make use of any suitable telecommunications network and may involve different hardware, different software and/or different protocols then those discussed below. FIGS. 1, 3-4, and 14-15 can include a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments. These transactions are processed through the network's authorization, clearing and settlement services. Authorization occurs when an issuer approves or declines a sales transaction before a purchase is finalized or cash is dispersed. Clearing occurs when a transaction is delivered from an acquirer to an issuer for posting to the customer's account. Settlement is the process of calculating and determining the net financial position of each member for all transactions that are cleared. The actual exchange of funds is a separate process.

In at least some implementations, the system may include one or more processors (e.g., digital signal processors, microprocessors, etc.), each being adapted to execute instructions to perform at least some of the methods, operations, and processes described herein with respect to the figures. Such instructions may be stored or held in storage media as instructions. Moreover, a non-transient computer readable medium can include such software as instructions executed by hardware to perform steps of methods described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described databases for storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

In the preceding detailed description, numerous specific details have been set forth to provide a thorough understanding of claimed subject matter. However, it will be understood by those skilled in the art that claimed subject matter may be practiced without these specific details. In other instances, methods and systems that would be known by one of ordinary skill have not been described in detail so as not to obscure claimed subject matter.

What is claimed is:

1. A method comprising a plurality of steps each being performed by hardware executing software, wherein the steps include:
obtaining from one or more databases, using information derived from a Globally Unique Identifier (GUID) for a merchant, merchant data for the merchant that includes:
a geographic address for the merchant;
a default affinity entity;
a default maximum travel time to the geographic address for the merchant; and
a default business rule obligating the merchant to donate to the affinity entity;
storing the merchant data for the merchant in one or more databases; and
processing information derived from an authorization response for a transaction conducted by the merchant on an account issued to an account holder, wherein the information includes identifiers for the merchant and for the account holder and a currency amount of the transaction, by:
retrieving, using the identifier for the merchant, at least a portion of the stored merchant data for the merchant;
accessing from one or more databases, using information derived from the identifier for the account holder, account holder data for the account holder that includes a geographic address for the account holder;
inquiring, using the geographic addresses for the account holder and the merchant, the travel time from the geographic address of the account holder to the geographic address of the merchant; and
if the inquired travel time is within a predetermined tolerance of the default maximum travel time, deriving, using the default business rule and the currency amount of the transaction, a donation to be made by the merchant to the default affinity entity.

2. The method as defined in claim 1, wherein the steps further comprise repeating:
the obtaining and storing steps for each of a plurality of said merchants; and
the processing step for each of a plurality of said transactions.

3. The method as defined in claim 2, wherein the processing step further comprises transmitting a message to a logical address of the merchant containing the donation to be made by the merchant to the default affinity entity.

4. The method as defined in claim 3, wherein the logical address to which the message and the determined difference are transmitted is selected from the group consisting of:
a logical address for the merchant;
a logical address for the account holder;
a logical address of the affinity entity;
a logical address of an agent for at least one of the merchant, the account holder and the affinity entity; and
a combination thereof.

5. The method as defined in claim 2, wherein the steps further comprise, a predetermined time period after said plurality of said transactions:
receiving a plurality of donation receipts, wherein:
each said donation receipt includes:
identifiers for the merchant and the default affinity entity; and
a currency amount donated by the merchant to the default affinity entity;
and
for each said default affinity entity and each said merchant:
determining a difference between the sum of:
the donations to be made by the merchant to the default affinity entity in the messages to the logical address of the merchant; and
the currency amount donated by the merchant to the default affinity entity in the donation receipts;
and
transmitting the determined difference to a logical address.

6. The method as defined in claim 5, wherein the logical address to which the determined difference is transmitted is selected from the group consisting of:
a logical address for the merchant;
a logical address for the account holder;
a logical address of the affinity entity;
a logical address of an agent for at least one of the merchant, the account holder and the affinity entity; and
a combination thereof.

7. The method as defined in claim 2, wherein:
each said transaction occurs in a payment processing system that includes a plurality of said merchants each conducting each said transaction on a respective said account issued to a respective said account holder by a respective issuer;
each said transaction on each said account is acquired for clearing and settlement by an acquirer for each said merchant through a transaction handler in communication with both the issuer of the account and the acquirer for the merchant; and
the issuer sends a corresponding said authorization response for the transaction to the merchant through the transaction handler and the acquirer in response to an authorization request sent to the issuer from the merchant through the transaction handler and the acquirer.

8. The method as defined in claim 2, wherein prior to repeating the processing step for each of a plurality of said transaction, receiving and making replacement changes for at least one:
said merchant to at least one of:
the default affinity entity corresponding to the geographic address for the merchant;
the default maximum travel time to the geographic address for the merchant; and
the default business rule obligating the merchant to donate to the affinity entity;
and
said account holder to the default affinity entity for a donation that is to be made by the merchant for each said transaction with said account holder.

9. The method as defined in claim 1, wherein the default affinity entity corresponds to the geographic address for the merchant.

10. The method as defined in claim 2, wherein the processing step further comprises transmitting a message to a logical address of the merchant containing the donation to be made by the merchant to the default affinity entity.

11. The method as defined in claim 2, wherein the processing step further comprises, for each transaction:
transmitting a message containing a question to a logical address of the account holder; and
after receiving, in response to the question, an answer:
incrementing a loyalty currency attributed to at least one of the account holder and the default affinity entity; and
transmitting a message to the logical address of the account holder containing acknowledgement of the increment to the loyalty currency.

12. The method as defined in claim 11, wherein when the time lapse between the question transmitted and the answer received is within a predetermined tolerance, the increment to the loyalty currency is greater than the increment if the time lapse is not within the predetermined tolerance.

13. The method as defined in claim 11, wherein the steps further comprise transmitting a message containing the answer to a logical address for at least one of the merchant and an agent of the merchant.

14. A non-transient computer readable medium comprising software executed by hardware to perform the steps of the method as defined in claim 1.

15. A method comprising a plurality of steps each being performed by hardware executing software, wherein the steps include:
auto-populating, for a merchant, an address, duration, and a rule obligating a donation to a donee;
using information from an authorization response for a transaction conducted by the merchant on an account of an account holder to obtain a travel time of the account holder from its address to the auto-populated address; and
when travel time is within a predetermined threshold of the auto-populated duration, deriving a donation, using the auto-populated rule and a currency amount of the transaction, that the merchant is obligated to make to the auto-populated donee.

16. The method as defined in claim 15, wherein the steps further comprise repeating:
the auto-populating step for each of a plurality of said merchants; and
the obtain step and the deriving step for each of a plurality of said transactions.

17. The method as defined in claim 16, wherein the deriving step further comprises, for each transaction:
transmitting a message containing a question to a logical address of the account holder; and
after receiving, in response to the question, an answer:
incrementing a loyalty currency attributed to at least one of the account holder and the auto-populated donee; and
transmitting a message to the logical address of the account holder containing acknowledgement of the increment to the loyalty currency.

18. The method as defined in claim 17, wherein when the time lapse between the question transmitted and the answer received is within a predetermined tolerance, the increment to the loyalty currency is greater than the increment if the time lapse is not within the predetermined tolerance.

19. A non-transient computer readable medium comprising software executed by hardware to perform the steps of the method as defined in claim 15.

20. A method comprising a plurality of steps each being performed by hardware executing software, wherein the steps include:
auto-populating, for each of a plurality of merchants, an address, duration, and a rule obligating a donation to a donee;
for each of a plurality of transactions between respective said merchants and respective account holders on an account issued to the account holder:
using information from an authorization response for the transaction to obtain a travel time from an address retrieved for the account holder to the auto-populated address for the merchant; and
when the obtained travel time is within a predetermined threshold of the auto-populated duration for the merchant, deriving a donation, using the auto-populated rule for the merchant and a currency amount of the transaction, that the merchant is obligated to make to the auto-populated donee.

21. The method as defined in claim 20, wherein the steps further comprise repeating:
the auto-populating step for each of a plurality of said merchants; and
the obtain step and the deriving step for each of a plurality of said transactions.

22. The method as defined in claim 21, wherein the deriving step further comprises, for each transaction:
transmitting a message containing a question to a logical address of the account holder; and
after receiving, in response to the question, an answer:
incrementing a loyalty currency attributed to at least one of the account holder and the auto-populated donee; and
transmitting a message to the logical address of the account holder containing acknowledgement of the increment to the loyalty currency.

23. The method as defined in claim 21, wherein:
each said transaction occurs in a payment processing system that includes a plurality of said merchants each conducting each said transaction on a respective said account issued to a respective said account holder by a respective issuer;
each said transaction on each said account is acquired for clearing and settlement by an acquirer for each said merchant through a transaction handler in communication with both the issuer of the account and the acquirer for the merchant; and
the issuer sends a corresponding said authorization response for the transaction to the merchant through the transaction handler and the acquirer in response to an authorization request sent to the issuer from the merchant through the transaction handler and the acquirer.

24. A non-transient computer readable medium comprising software executed by hardware to perform the steps of the method as defined in claim 20.
